(19) United States
(12) Patent Application Publication
(10) Pub. No.: US 2008/0122930 A1
(43) Pub. Date: May 29, 2008

(54) Image processor, intruder monitoring apparatus and intruder monitoring method

(76) Inventors: Yoichi Takagi, Hitachi-shi (JP); Hiroshi Suzuki, Hitachi-shi (JP); Kunizo Sakai, Hitachi-shi (JP); Yoshiki Kobayashi, Hitachi-shi (JP); Takeshi Saito, Hitachi-shi (JP)

Correspondence Address: KENYON & KENYON LLP, 1500 K STREET N.W., SUITE 700, WASHINGTON, DC, 20005, US

(21) Appl. No.: 12/007,636

(22) Filed: Jan. 14, 2008

Related U.S. Application Data
(63) Continuation of application No. 10/842,527, filed on May 11, 2004, now abandoned.
Application No. 10/842,527 is a continuation of application No. 08/932,649, filed on Sep. 18, 1997, now abandoned.

(30) Foreign Application Priority Data
Sep. 20, 1996 (JP) 8-249728
Aug. 7, 1997 (JP) 9-212985

(51) Int. Cl. H04N 7/18

(52) U.S. Cl. 348/152; 348/E07.085

(57) ABSTRACT

An intruder monitoring apparatus has at least a feature of correcting characteristic quantities by which an object to be monitored is specified, on the basis reference characteristic, when any change occurs in conditions of the video devices and environments. A further feature is provided which a plurality of scenes are monitored periodically by one camera and an image analysis function is driven so as to monitor any intruder only when the camera unit is fixedly directed to a specific scene among the scenes.

### BACKGROUND OF THE INVENTION

The present invention relate to a monitoring apparatus with an image processor and a monitoring method and, more particularly, to an intruder monitoring apparatus with an image processor and an intruder monitoring method, each of which is suitable for taking a camera picture inside or outside a house into the image processor and detecting abnormality by image analysis thereof.

Hitherto, in very many cases, intruder monitoring was done by taking picture with an industrial TV camera (hereinafter, referred to as an ITV camera) and watching at the camera picture by person's eyes. With a monitoring apparatus in which a camera attitude can be freely changed, it is difficult to detect an abnormal condition by image analysis and, in usual, monitoring was effected by watching at the camera picture by person's eyes, which is disclosed in JP A 6-233308.

In the conventional monitoring system by ITV camera and by watching with person's eyes, it is necessary to increase the number of monitoring persons as the number of cameras installed for monitoring increases. Further, continuous monitoring of the monitor pictures for long time is bad for health of the person. Therefore, automatic monitoring is strongly desired. Further, recently, a scope to be monitored becomes wider and wider, and such a problem occurs that many cameras must be provided to cover the wide scope when a system is taken in which the cameras each are fixed so that automatic monitoring can be easily employed.

Further relevant prior arts can be listed as follows:

JP A 3-270586 discloses an infrared ray monitoring system in which one infrared camera is rotated periodically to direct to a plurality of view fields and an image processor is driven to effect image processing only when the camera keeps still.

JP A 6-225310 discloses an industrial plant monitoring apparatus in which one TV camera monitors a plurality of objects while switching, camera position control information and camera lens control information are provided in a table, and the information can be changed by a man-machine.

JP A 7-7729 is concerned with a shooting apparatus of a plurality of view fields. This discloses conventional two methods as shown in FIG. 6, one of which is a method wherein the number of cameras corresponding to the number of fields are prepared to take a plurality of view fields and the other is a method wherein one camera is provided and rotated to direct to each object and take necessary numbers of fields.

JP A 3-227191 discloses an industrial TV operation apparatus in which one TV camera is automatically moved to a plurality of monitoring places in a preset order and the places are viewed by person's eyes.

JP A 8-123964 discloses a model pattern register method and apparatus in which the center of a register object is taken as a reference coordinate, edges of the register object are extracted, a frame of four sides is set on the basis of the edges, and a model pattern is formed from the image data within the frame and registered.

U.S. Pat. No. 5,473,368 discloses an interactive surveillance device which has a plurality of passive infrared detectors and a camera. When an infrared detector among the detectors detects an intruder, the camera is moved to direct to the intruder, thereby monitoring it.

U.S. Pat. No. 5,109,278 discloses a video monitoring system which responds to an intrusion alarm by automatically presenting still video images of the zone of the alarm at or about the time of the alarm. The operator can control magnification and contrast to enhance the displayed image.

### SUMMARY OF THE INVENTION

An object of the present invention is to provide an intruder monitoring apparatus and an intruder monitoring method, each of which sure monitoring through image processing can be effected even a change occurs in camera shooting conditions such as a change in zooming, a camera attitude, a geometrical relation of a region to be monitored and the camera, etc.

For example, the object of the invention includes such a case where when an ITV camera picture or image is taken into an image processor and abnormality is detected by analysis of the image, the intruder monitoring apparatus or method does not cause any trouble in a function of detecting the abnormality by image processing even if an operation such as zooming accompanied by a change in size of an image of an object inside the input image is performed to observe the object more in detail.

Further, the object of the invention includes such a case where when an ITV camera picture or image is taken into an image processor and abnormality is detected by analysis of the image, the intruder monitoring apparatus or method does not cause any trouble in a function of detecting the abnormality by image processing even if an operation such as changing a camera direction whereby a distance between an object and the camera changes is performed in order to shift a monitoring zone.

Further, the object of the invention includes such a case where when an ITV camera picture or image is taken into an image processor and abnormality is detected by analysis of the image, the intruder monitoring apparatus or method, which is able to monitor a wide range by one ITV camera, does not cause any trouble in a function of detecting the abnormality by image processing even if an operation such as a changing operation of a camera direction thereby to change a monitoring zone and a zooming operation are performed at the same time.

Another object of the present invention is to provide an image processor which is suitable for analysis of images to specify a specific image or images inside a camera picture.

Further another object of the present invention is to solve such a problem that an object can not be specified correctly for the reason that the size appears to be a different size due to strain of the image of the object caused by a difference in distance between the object and the camera, even inside the same picture frame.

Still further another object of the present invention is to provide an intruder monitoring apparatus and method which is able to automatically monitor a relatively wide range of space by one camera.

The present invention is characterized in that characteristic quantities of an object are prepared under certain conditions of taking picture or shooting, the characteristic quantities are renewed or corrected according to a change in the taking picture conditions, and the object is detected by image processing, based on the renewed characteristic quantities.

An intruder monitoring apparatus according to the present invention, comprises a monitoring camera for monitoring an object, an image processor for analyzing an image from the monitoring camera, a video device controller for controlling video devices including the monitoring camera, means for managing at least one kind of information selected from a group of video device control information used for controlling the video devices, object characteristic quantity information which is information concerning characteristic quantities of the object, and a topographic information of an area to be monitored, means for teaching the image processor characteristic quantities of an object and means for correcting the characteristic quantities, on the basis of which image analysis is effected, when any change occurs in conditions of the video devices and environments.

In an aspect of the present invention, control information concerning a camera zooming operation is transferred to the image processor to influence on processing of abnormal object detection by image processing. Concretely, a view field angle φ corresponding to a zoom value set when teaching processing is performed for detecting the abnormal object is memorized in a video device control information table and an object characteristic quantity management table. When the zoom value is changed, a reference characteristic quantity is renewed. These processing are desirable to be always performed in synchronism with camera operation.

In another aspect of the present invention, control information concerning a camera attitude is transferred to the image processor to influence on processing of abnormal object detection by image processing. Concretely, reference characteristic quantities of an object that is abnormality is detected are always renewed by incorporating a change in the camera attitude into abnormality detection processing of the image processing. The characteristic quantities of the abnormality detection object are renewed or corrected, for example, by distance between the camera and the object. Since the distance between the camera and the object changes according to the camera attitude, in order to estimate the distance, the apparatus is constructed so that the distance can be always renewed from a change in the camera attitude by, in advance, incorporating a geometric model specific to the system and inputting the elevation (or height on the ground) of the camera. These processing are desirable to be always performed in synchronism with camera operation.

In another aspect of the present invention, control information concerning camera zooming operation and a camera attitude is transferred simultaneously to the image processor to influence on processing of abnormal object detection by image processing. The apparatus is constructed so that reference characteristic quantities of an object that an abnormality is detected are always renewed by incorporating a change in the camera attitude in addition to a change in zoom value into abnormality detection processing of the image processing. These processing are desirable to be always performed in synchronism with camera operation.

In another aspect of the present invention, in a case where any abnormal object is detected in the camera picture, the position of a part of the abnormal object in contact with the ground surface is measured, and the characteristic quantities are corrected by a distance between it and the center of the scene.

In another aspect of the present invention, an intruder monitoring apparatus is provided, which comprises a camera unit of a camera and a mechanism mounting the camera thereon, allowing a shooting direction of the camera to be movable, a camera controller for controlling the camera unit so that a plurality of scenes can be taken with passage of time, an image processor connected to the camera to receive video signal therefrom and having an image analysis, a system controller, connected to the camera controller and the image processor, for controlling the camera controller and the image processor, wherein there is provided with a function that a plurality of scenes are monitored periodically by the one camera and the image analysis function is driven so as to monitor any intruder only when the camera unit is fixedly directed to a specific scene among the scenes.

### BRIEF DESCRIPTION OF THE DRAWINGS

FIG. 1 is an embodiment of an intruder monitoring apparatus with an image processor according to the present invention;

FIG. 2a is an illustration of setting conditions of video system at a time of teaching;

FIG. 2b is an illustration of camera images at the time of teaching in FIG. 2a;

FIG. 2c is an illustration of setting conditions of video system in which only zooming condition is changed at a fixed angle of elevation β;

FIG. 2d is an illustration of camera images at the setting conditions in FIG. 2c;

FIG. 3a is an illustration of setting conditions of video system in which the angle of elevation β is changed;

FIG. 3b is an illustration of camera images input under the setting conditions in FIG. 3a;

FIG. 3c is an illustration of setting conditions of video system in which the elevation is changed further to change in the angle of elevation β;

FIG. 3d is an illustration of camera images input under the setting conditions after zooming at a fixed β;

FIG. 4 is an illustration of video system model at the time of teaching;

FIG. 5a is an illustration of video system model in which an angle of elevation and a view field angle are changed in the same time;

FIG. 5b is an illustration of a portion of FIG. 5a enlarged in part;

FIG. 6 is an illustration of optical model at the time of camera shooting;

FIG. 7 is a whole flow chart of an intruder monitoring processing;

FIG. 8 is a flow chart of teaching processing of an object to be monitored;

FIG. 9 is a flow chart of storing processing of teaching results into a table;

FIG. 10 is a flow chart of processing of camera attitude control and zooming control;

FIG. 11 is a flow chart of correction processing of characteristic quantities;

FIG. 12 is a flow chart of monitor-processing;

FIG. 13 is an example of a data object characteristic quantity management table;

FIG. 14 is an example of a data table for obtaining H2 from β and γ;

FIG. 15 is an example of a data table for obtaining H2 from β;

FIG. 16 is another embodiment of an intruder monitoring apparatus according to the present invention;

FIG. 17 is an illustration of an example of a monitoring scene;

FIG. 18 is an illustration of an example of a monitoring area set in a monitoring area;

FIG. 19 is an illustration of an example of a program for a control apparatus;

FIG. 20 is a flow chart of an example of election processing of monitoring conditions;

FIG. 21 is a flow chart of an example of processing of setting of camera conditions and scene number;

FIG. 22 is a flow chart of an example of processing of setting of a monitoring area;

FIG. 23 is a flow chart of an example of processing of setting a specification of an object to be monitored;

FIG. 24 is an illustration of an example of a means for forming object models on a monitor screen;

FIG. 25 is an illustration of an example of a means for adding a shadow to an object to be monitored;

FIG. 26 is a flow chart of an example of processing of setting of scene monitoring schedule;

FIG. 27 is a flow chart of an example of processing of monitor-processing start;

FIG. 28 is a flow chart of an example of processing of monitor-processing stop;

FIG. 29 is a flow chart of an example of monitor-processing management;

FIG. 30 is a flow chart of an example of processing by an image processor;

FIG. 31 is a flow chart of an example of intruder monitor-processing by image analysis;

FIG. 32 is a flow chart showing a flow of data on the apparatus according to the present invention;

FIG. 33 is a time chart of processing by the apparatus according to the present invention; and

FIG. 34 is an illustration of a table construction.

### DESCRIPTION OF EMBODIMENTS OF THE INVENTION

An embodiment of the present invention will be described hereunder in detail, referring to the drawings.

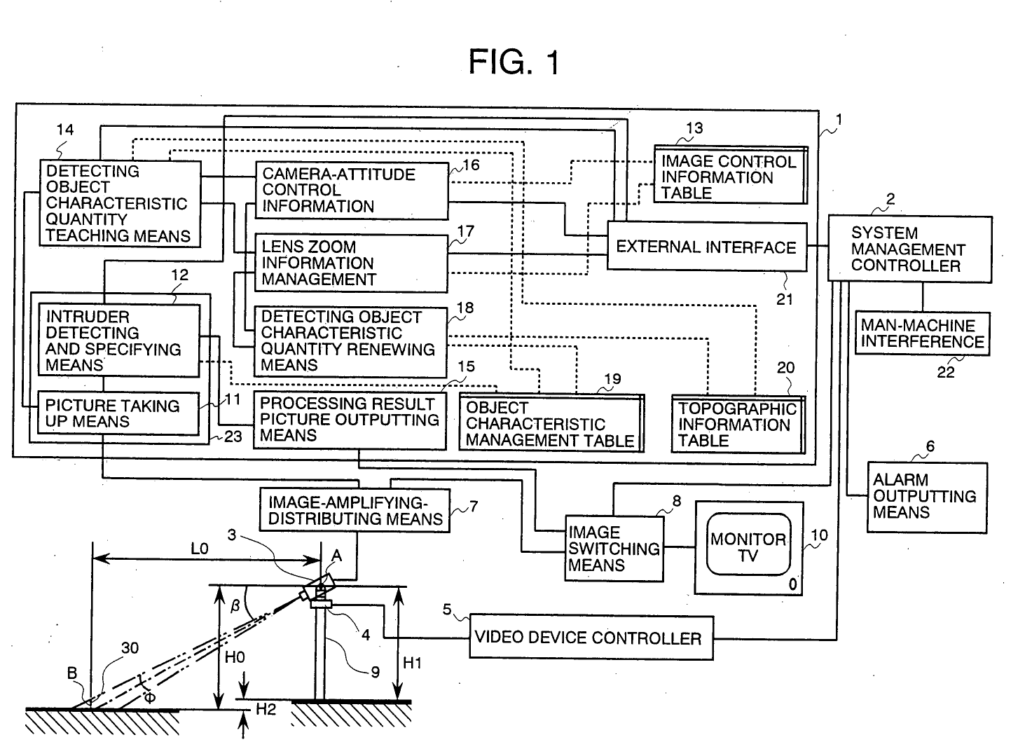

In FIG. 1, an intruder monitoring apparatus including an image processor of an embodiment of the invention is shown. The intruder monitoring apparatus comprises a main unit 1 of the intruder monitoring apparatus, a system management controller 2, a man-machine interface 22, an alarm or alarm output means 6, an ITV camera 3, a movable table 4 which rotatable about a vertical axis and tiltable about a horizontal axis, a video device controller 5, an image amplifying distributing means 7, an image switching means 8, a monitor TV 10 for monitoring, etc. The intruder monitoring apparatus main unit 1 comprises an external interface 21, an image taking up means 11, an intruder detecting and specifying means 12, a detection object characteristic quantity teaching means 14, a processing result picture outputting means 15, a camera attitude control information managing means 16, a lens zoom information managing means 17, an video device control information table 13, a detection object characteristic renewing means 18, an object characteristic quantity management table 19 and a topographic information table 20.

With this construction of the intruder monitoring apparatus, a detection object 30 (an object to be detected or monitored) on the ground is taken picture by the ITV camera 3, the camera video signals are transmitted to the image amplifying distributing means 7 by which the camera video signals are amplified and distributed to the intruder monitoring apparatus main unit (image processing unit) 1 and the monitor TV 10 provided for monitoring by the seeing of a person. When any abnormal condition is detected by image processing of the camera video signals, an alarm is outputted by the alarm, so that an operator can confirm the abnormal condition in detail by the monitor TV 10.

When it is desired to change the monitoring place or monitor the place in detail, it is possible to zoom in or out by the ITV camera 3 and change the attitude of the camera by operation of an operator, using the man-machine interface 22. The operation such as the zooming, attitude changing is performed as follows.

The man-machine interface is operated by an operator to effect the zooming and attitude changing to output operation signals. The operation signals are transmitted to the video device controlling means 5 through the system management controlling means 2. The video device controlling means 5 generates control signals for controlling movement of video devices such as the movable table 4, a zooming device (not shown) of the ITV camera 3, to control the zooming in or out and the attitude change of the camera. The control results are transmitted to the system management controlling means 2, and then to the intruder monitoring apparatus main unit 1. In the intruder monitoring apparatus main unit 1, those signals are inputted through the external interference 21, and transferred to the camera attitude control information managing means 16 and the lens zoom information managing means 17. The camera attitude control information managing 16 memories and stores the camera attitude control information, and starts to operate the detection object characteristic quantity renewing means 18. The lens zoom information managing means 17 memorizes and stores the zoom control information, and starts to operate the detection object characteristic quantity renewing means 18. When the zoom and the camera attitude are renewed, their characteristic quantities are renewed timely. The camera attitude control information and the zoom control information are memorized in the video device control information table 13.

The detection object characteristic quantity teaching means 14 has a function of taking up specific pictures including a person or persons, a vehicle or vehicles, measuring the characteristic quantities of the person and vehicle by image analysis, and storing the information in the video device characteristic quantity management table 13. As characteristic quantities, height and area are used in many cases, but other various kinds of quantities such as peripheral length, slenderness ratio, etc. can be used. Any characteristic quantities can be used if they can specify a detection object such as a person, a vehicle, etc.

Here, the concept is explained hereunder, using height and area.

Taught characteristic quantities can not be used after the conditions of zoom and camera attitude have changed, so that the taught characteristic quantities are renewed when any change in conditions occurs. This processing is performed by the detection object characteristic quantity renewing means 18. The camera picture is taken up by the picture taking in means 11, and the intruder detecting and specifying means 12 examines whether or not any intruder appears in the picture. When any intruder is detected, specification of whether it is a person, a vehicle, or other is conducted. The result is transmitted to the system management controlling means 2 through the external interference 21 and noticed by the alarm 21. The processing result also is transmitted to the processing result output picture means 15 to output a video signal for the processing result picture, and the processing result is displayed as picture on the monitor TV 10.

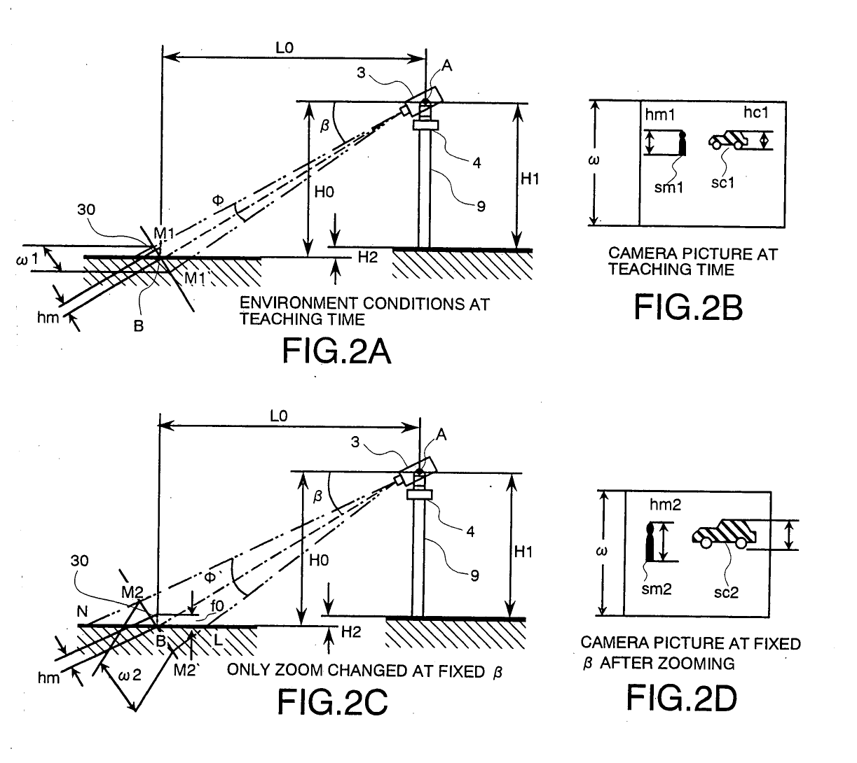

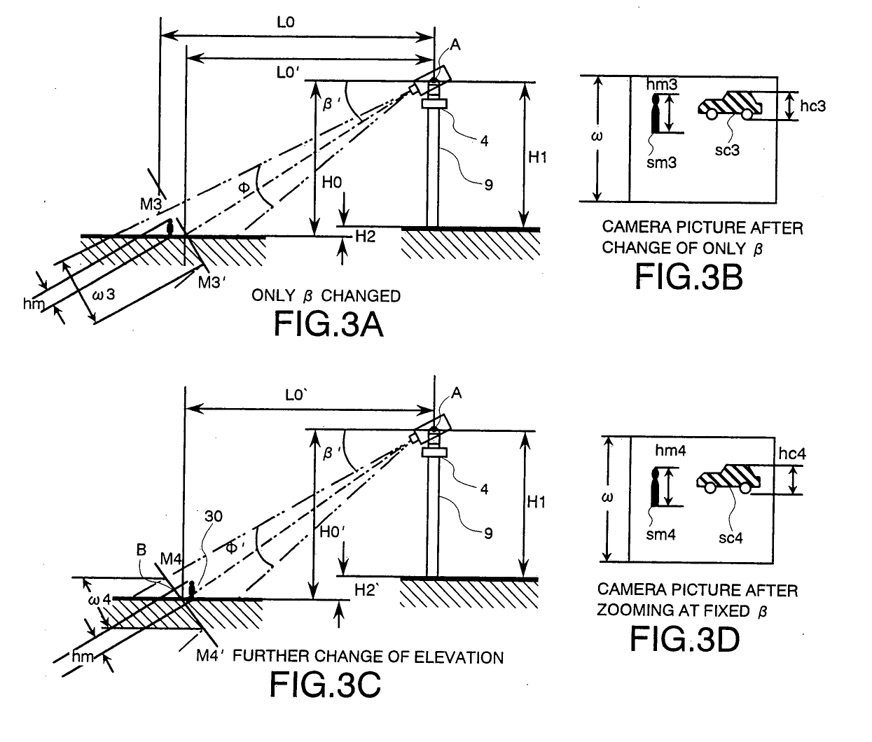

A concept of renewal of the characteristic quantifies is explained hereunder, referring to FIGS. 2a to 2d and FIGS. 3a to 3d.

FIG. 2a shows a video system installation environment at the time of teaching of an object. In a case where an elevation (height from a sea level) at the camera installation position is taken as a reference position, the camera is to be set at a difference in elevation H1. Assuming that a cross point of a camera view line and the ground is B, a difference in elevation between the camera installation point and the point B is H2. Accordingly, an elevation difference between the point B and the camera is H0=H1+H2. An angle of elevation is β which is changeable by camera attitude control. An angle of the field of view of the camera is φ. The angle φ is variable by zoom control. The angles β and φ each are controlled by the video device controlling means 5. Values of the angle β are memorized and stored by the camera attitude control managing means 16 and the video device control information table 13. Values of the angle φ are memorized and stored by the lens zoom information managing means 17 and the video device control information table 13.

A detection object (an object to be detected) 30 exists about the point B on the ground, and the characteristics of the detection object 30 are determined by information such as the scale of the object, the area on the video screen or picture, etc. The processing for determining the characteristics of the detection object in this manner is called as a teaching processing, hereunder. The elevation difference H2 on the ground surface between the point B and the camera installation point is determined by deciding the orientation (angle of elevation) β of the camera. Those topographical data are memorized in advance in the topographic information table 20. That is, the point B can be obtained geometrically as a cross point between the camera view field and the ground surface, using an altitude map information, and at the same time, an elevation value at the point B also can be obtained.

FIG. 2b is an example of a picture input in the camera under the environment conditions at the time of teaching, shown in FIG. 2a. A person and vehicle as objects appear in the camera picture.

The real height of the person is hm, but his height in the picture becomes hm1. The height of the vehicle is hc1 in the picture. Further, the areas of the person and vehicle in the picture are sm1 and sc1, respectively. The height of the picture is ω and always constant. The scale ω1 of the real scene height M1-M1′ corresponding to the picture height ω can be calculated according to the following equation;

ω1=2×\sqrt{(L0²+H0²)}×tan(φ/2) (1)

where L0=H0/tan β.

It is assumed that the real height of the person, vehicle and others are hm, hc and hi, respectively, and the height of them are hm1, hc1 and hi1 in the picture, respectively. In a case of the person, the following relation is established;

hm:ω1=hm1:ω.

### In the case of the vehicle and others also, the similar relations are established.

The relation in the case of person cam be expressed as follow;

hm/ω1=hm1/ω=κm1 (2)

here, κm1 is memorized as a teaching parameter.

A relation in a case of vehicle is as follow;

hc/ω1=hc1/ω=κc1 (3)

here, κc1 is memorized as a teaching parameter.

A relation in a case of others is as follow;

hi/ω1=hi1/ω=κi1(i=i1−in) (4)

here, κi1 (i=i1−in) is memorized as a teaching parameter.

Next, it is assumed that the areas of the person, vehicle and others are sm, sc and si, respectively and the areas in the picture of the person, vehicle and others are sm1, sc1 and si1, respectively.

In a case of the person, the relation: sm:ω1²=sm1: ω₂ is established. In a case of the vehicle and other objects, the similar relations are established.

In a case of person,

sm/ω1²=sm1/ω²=λm1 (5)

In a case of vehicle,

sc/ω1²=sc1/ω²=λc1 (6)

### In a case of other objects,

si/ω1²=sm1/ω²=λi1(i=i1−in) (7)

By taking up a teaching picture and having measured parameters such as κm1, κc1, κi1, λm1, λc1, λi1, etc. by picture analysis, a person, a vehicle and other objects each can be specified, which will be described hereunder. Here, it is assumed that the camera is installed on a flat surface of the ground. It can be imaged that when the camera is revolved at a fixed angle of elevation β, an elevation difference between a camera installation point and the cross point B of the camera view line and the ground surface is constant and does not change. In a case where the camera is operated under those conditions, it will be understand that the detection object is specified to any one of a person, vehicle and other objects by evaluating the height and areas of the picture of the person, vehicle and other objects detected in the input picture. When a picture is input under the above-mentioned conditions, it is assumed that a picture of a height hx and an area sx is detected. The detected picture will be specified to be a person when the following two equations are satisfied;

κm1×(1−Δ)≦hx/ω≦κm1×(1+Δ) (8)

λm1×(1−Δ)≦hx/ω²≦λm1×(1+Δ) (9)

wherein Δ is a value determined by what extent of variation a real value hm and a picture value hm1 have in a case of a person.

In the similar manner, the detected picture will be specified to be a vehicle when the following two equations are satisfied;

κc1×(1−Δ)≦hx/ω≦κc1×(1+Δ) (10)

λc1×(1−Δ)≦hx/ω²≦λc1×(1+Δ) (11)

Next, FIG. 2c is an example in which the camera installation environment conditions shown in FIG. 2a are changed in part and the view field angle φ is changed to φ′. The camera is inclined at the angle of elevation B against the ground surface and not changed. The camera view field angle is φ which is a value changed by zooming. An object 30 to be detected is disposed around a point B on the ground surface, the object 30 is specified by information such as the size of the object, the area in the picture, etc. Processing of specifying the object at this time is almost the same as in the case of FIG. 2a. The difference is in that the teaching is not conducted in this time. It is intended to effectively use the conditions taught in FIG. 2a.

FIG. 2d is an example of a picture input in the camera in the case of FIG. 2c. As detection objects, a person and a vehicle appear in the picture. The real heights of the person, vehicle and other objects are hm, hc and hi, and their heights on the picture are hm2, hc2 and hi2, respectively. The real areas of the person, vehicle and other objects are sm, sc and si and their areas on the picture are sm2, sc2 and si2, respectively. The scale ω2 of the real scene height M2-M2′ corresponding to the picture height ω can be calculated according to the following equation;

ω2=2×\sqrt{(L0²+H0²)}×tan(φ′/2) (12)

As for the person, the following equation is established;

hm/ω2=hm2/ω=κm2 (13)

In a case of the vehicle;

hc/ω2=hc2/ω=κc2 (14)

### A relation in a case of the other objects is as follow;

hi/ω2=hi2/ω=κi2(i=i1−in) (15)

Next, as for the areas, the following equations are established in the same manner as above.

In a case of person,

sm/ω2²=sm2/ω²=λm2 (16)

In a case of vehicle, the area of vehicle in the picture is taken as sc2, the following equation is established;

sc/ω2²=sc2/ω²λc2 (17)

In a case of other objects,

si/ω2²=si2/ω²=λi2(i=i1−in) (18)

Here, parameters such as κm2, κc2, κi2, λm2, λc2, λi2, etc. are unknown, however, they can be calculated from the previously taught parameters. The calculation method will be described hereunder.

κm2 can be obtained from the equation 2 and the equation 13 as follows:

κm2=κm1×ω1/ω2 (19)

κc2 can be obtained from the equation 3 and the equation 14 as follows:

κc2=κc1×ω1/ω2 (20)

κi2 can be obtained from the equation 4 and the equation 15 as follows:

κi2=κi1×ω1/ω2 (21)

λm2 can be obtained from the equation 5 and the equation 16 as follows:

λm2=λm1×(ω1/ω2) (22)

λc2 can be obtained from the equation 6 and the equation 17 as follows:

λc2=λc1×(ω1/ω2)² (23)

λi2 can be obtained from the equation 7 and the equation 18 as follows:

λi2=λi1×(ω1/ω2)² (24)

In this manner, the parameters κm2, κc2, κi2, λm2, λc2, λi2 after the view filed angle is changed to φ′ by zooming are obtained. The characteristics such as the height, area, etc. in the picture of the person, vehicle, etc. are obtained, using the equations 13 to 18.

hm2=κm2×ω (25)

hc2=κc2×ω (26)

hi2=κi2×ω(i=i1−in) (27)

sm2=λm2×ω² (28)

sc2=λc2×ω² (29)

si2=λi2×ω²(i=i1−in) (30)

In a case where when a camera picture is input under condition such as in FIG. 2c, an object of height hx, area sx is detected in the picture, it is specified as follows:

In a case where the following two equations are satisfied, such a case will be specified to be a person.

κm2×(1−Δ)≦hx/ω≦κm2×(1+Δ) (31)

λm2×(1−Δ)≦hx/ω≦λm2×(1+Δ) (32)

Here, Δ is a value determined by what extent of variation a real value hm and a picture value hm1 have in the case of person.

In the similar manner, in a case where the following two equations are satisfied, such a case will be specified to be a vehicle.

κc2×(1−Δ)≦hx/ω≦κc2×(1+Δ) (33)

λc2×(1−Δ)≦hx/ω²≦λc2×(1+Δ) (34)

Next, a case where the angle of elevation β changed to β′ as in FIG. 3a is explained. A difference in elevation between an camera installation point and a cross point B of a camera view line and the ground surface is H0, and this case is the same as in FIG. 2a except for the angle of elevation β′. That is, this case is an example in which the camera angle of elevation is changed against a flat ground surface. A person, vehicle and other objects have real height of hm, hc, hi, respectively, and they have height in the picture of hm3, hc3, hi3, respectively, and areas in the picture of sm3, sc3 and si3. A picture height is ω. The scale ω3 of the height M3-M3′ of a real scene corresponding to the picture height ω can be calculated by the following equations:

ω3=2×\sqrt{(L0′²+H0²)}×tan(φ/2) (35)

where L0′=H0/tan β′.

In this case also, the following equations are established.

hm/ω3=hm3/ω=κm3 (36)

hc/ω3=hc3/ω=κc3 (37)

hi/ω3=hi3/ω=κi3(i=i1−in) (38)

sm/ω3²=sm3/ω²=λm3 (39)

sc/ω3²=sc3/ω²=λc3 (40)

si/ω3²=sm3/ω²=λi3(i=i1−in) (41)

The parameters in the above-equations are calculated from the results of teaching. From the equations 2 to 7 and the equations 36 to 41, the following equations are derived:

κm3=κm1×ω1/ω3 (42)

κc3=κc1×ω1/ω3 (43)

κi3=κi1×ω1/ω3 (44)

λm3=λm1×(ω1/ω3)² (45)

λc3=λc1×(ω1/ω3)² (46)

λi3=λi1×(ω1/ω3)² (47)

In this manner, the parameters κm3, κc3, κi3, λm3, λc3, λi3 after the camera angle is modified to the angle of elevations β′ are obtained. The characteristics such as the height, area, etc. in the picture of the person, vehicle, etc. are obtained, using the equations 42 to 47.

hm3=κm3×ω (48)

hc3=κc3×ω (49)

hi3=κi3×ω(i=i1−in) (50)

sm3=λm3×ω² (51)

sc3=λc3×ω² (52)

si3=λi3×ω²(i=i1−in) (53)

In a case where an object of the height hx and the area sx in the camera picture input under conditions such as in FIG. 3a, the object is specified as follows:

When the following two equations are satisfied, the detected image will be able to be specified a person.

κm3×(1−Δ)≦hx/ω≦κm3×(1+Δ) (54)

λm3×(1−Δ)≦hx/ω²≦λ33×(1+Δ) (55)

Here, Δ is a value determined by what extent of variation a real value hm and a value hm3 in the picture have in the case of person.

In the similar manner, in a case where the following two equations are satisfied, such a case will be able to be specified a vehicle.

κc3×(1−Δ)≦hx/ω≦κc3×(1+Δ) (56)

λc3×(1−Δ)≦hx/ω²≦λc3×(1+Δ) (57)

Next, as in FIG. 3c, a case where the angle of elevation β, the view field angle φ and the difference in elevation on the ground surface are changed to β′, φ′ and H2′, respectively will be described. FIG. 3d is an input picture in this case. The cross point B between the camera view line and the ground surface can be geometrically calculated by inputing an orientation of the camera and an angle of elevation β′, using the topographic information table 20. Further, at the same time, a horizontal distance L0′ between the cross point B and the camera setting point and the difference in elevation H2′ between the ground surface can be obtained. Difference in elevation H0′ between the camera and the cross point B can be obtained as H0′=H1+H2′. A person, vehicle and other objects have real heights of hm, hc, hi, respectively, and they have heights in the picture of hm4, hc4, hi4, respectively, and areas in the picture of sm4, sc4 and si4. A picture height is ω. The scale ω4 of the height M4-M4′ of a real scene corresponding to the picture height ω can be calculated by the following equations:

ω4=2×\sqrt{(L0′²+H0′²)}×tan(φ/2) (58)

where L0′=H0′/tan β′.

In this case also the following equations are established.

hm/ω4=hm4/ω=κm4 (59)

hc/ω4=hc4/ω=κc4 (37)

hi/ω4=hi4/ω=κi4(i=i1−in) (61)

sm/ω4²=sm4/ω²=λm4 (62)

sc/ω4²=sc4/ω²=λc4 (63)

si/ω4²=sm4/ω²=λi4(i=i1−in) (64)

The parameters in the above-equations are calculated from the results of teaching.

κm4=κm1×ω1/ω4 (65)

κc4=κc1×ω1/ω4 (66)

κi4=κi1×ω1/ω4 (67)

λm4=λm1×(ω1/ω4)² (68)

λc4=λc1×(ω1/ω4)² (69)

λi4=λi1×(ω1/ω4)² (70)

In this manner, the parameters κm4, κc4, κi4, λm4, λc4, λi4 after the camera attitude is changed to the angle of elevation β′ and zoom φ′ are obtained. The characteristics such as the height, area, etc. in the picture of the person, vehicle, etc. are obtained, using the equations.

hm4=κm4×ω (71)

hc4=κc4×ω (72)

hi4=κi4×ω(i=i1−in) (73)

sm4=λm4×ω (74)

sc4=λc4×ω² (75)

si4=λi4×ω²(i=i1−in) (76)

In a case where an object of the height hx and the area sx in the camera picture input under conditions such as in FIG. 3c, the object is specified as follows:

When the following two equations are satisfied, the detected image will be able to be specified a person.

κm4×(1−Δ)≦hx/ω≦κm4×(1+Δ) (77)

λm2×(1−Δ)≦hx/ω²≦λm4×(1+Δ) (78)

Here, Δ is a value determined by what extent of variation a real value hm and a value hm4 in the picture have in the case of a person.

In the similar manner, in a case where the following two equations are satisfied, such a case will be able to be specified a vehicle.

κc4×(1−Δ)≦hx/ω≦κc4×(1+Δ) (79)

λc4×(1−Δ)≦hx/ω²≦λc4×(1+Δ) (80)

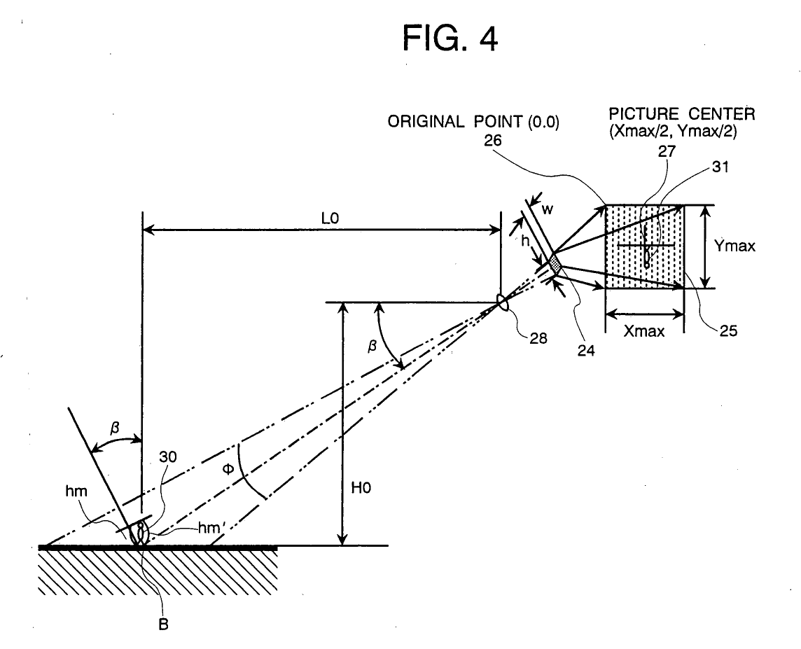

Next, a geometric model of a video system at the time of teaching is illustrated in FIG. 4. In FIG. 4, a number 28 denotes a lens of camera, 24 is a pickup camera screen, 25 is a picture memory of the image processing apparatus. A number 30 denotes a detection object and 31a picture or image of the object 30 in the picture screen. A number 27 denotes the center of the picture screen of the picture memory. Xmax and Ymax are maximum values of lateral and vertical sides, respectively. The picture height ω used in FIGS. 2a to 2d is equal to Ymax. Assuming that the real height of a person is hm′, when seen from the camera, hm is seen to be shrunk in a height direction as hm=hm′ X cos β by influence of the angle of elevation β. It is necessary that the object is disposed around the center of the picture screen at the time of teaching because the size on the picture screen changes according to the position even if the object is the same. If the above-mentioned concept is not contained in the conversion equation from teaching data of characteristic quantities, excellent specification can not be performed. That is, in a case where the angle of elevation β is changed, a clause or clauses of the angle of elevation β are incorporated in the characteristic quantity conversion equation. In the case of FIGS. 2a to 2d, such clauses are not incorporated because the angle of elevation β does not change. In a case of FIG. 3a, the above concept is necessary to be taken into consideration because the angle of elevation β differs that at the time of teaching. It will be noted that the equations 42 to 47 are modified as follows:

κm3=κm1×ω1/ω3×cos β′/cos β (81)

κc3=κc1×ω1/ω3×cos β′/cos β (82)

κi3=κi1×ω1/ω3×cos β′/cos β (83)

λm3=λm1×(ω1/ω3)²×cos β′/cos β (84)

λc3=λc1×(ω1/ω3)²×cos β′/cos β (85)

λi3=λi1×(ω1/ω3)²×cos β′/cos β (86)

In a case of FIG. 3c also, since β differs from that at the time of teaching, it is necessary to take a consideration. It is noted that the equations 65 to 70 are more appropriate when modified as follows:

κm4=κm1×ω1/ω4×cos β′/cos β (87)

κc4=κc1×ω1/ω4×cos β′/cos β (88)

κi4=κi1×ω1/ω4×cos β′/cos β (89)

λm4=λm1×(ω1/ω4)²×cos β′/cos β (90)

λc4=λc1×(ω1/ω4)²×cos β′/cos β (91)

λi4=λi1×(ω1/ω4)²×cos β′/cos β (92)

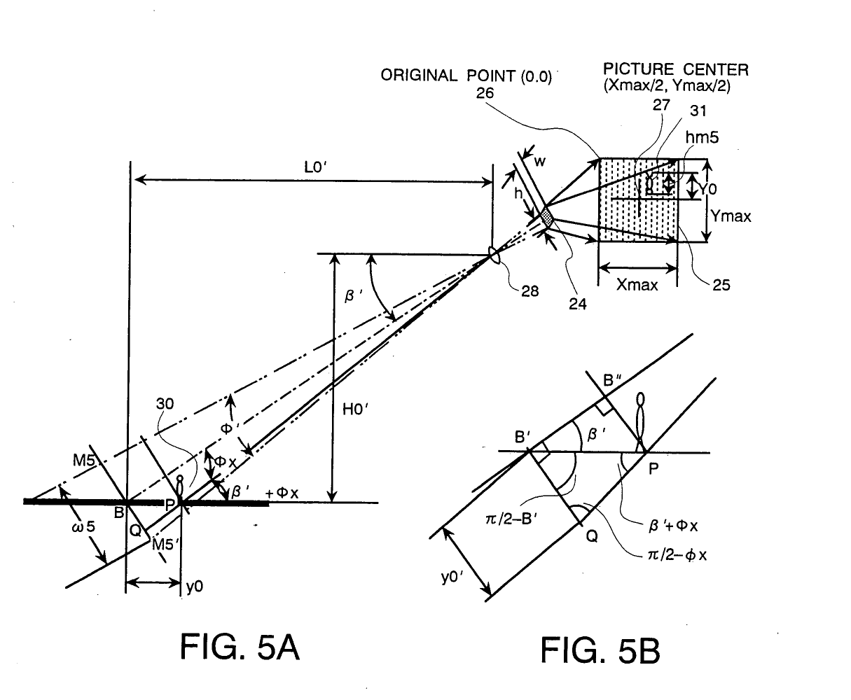

FIG. 5a shows a geometric model under conditions other than the teaching. That is, they are an angle of elevation β′, a view field angle φ′, a horizontal distance L0′ between the scene center B′ and the camera, and a perpendicular distance H0′. Further, FIG. 5a shows an example in which an object is disposed at a place separated from the scene center B′ by a distance y0. The method of renewing the characteristic quantities in a case where an object is disposed at the scene center B′ has been explained sufficiently, referring to FIGS. 2a to 2d and FIGS. 3a to 3d. Therefore, in FIG. 5a, an explanation is taken about a case where the object is separated from the scene center by y0. In the picture screen, it is seen that an coordinate of a lower portion of a foot of a person is separated from a picture memory screen center 27 by a vertical distance y0. It will be considered to calculate y0 from y0. FIG. 5b shows details around B′. In a triangle Δ B′ P Q, the following is known: Assuming that φX=φ/2×(y0/(Ymax/2)), the following is established:

∠B′QP=π/2−φX

∠PB′Q=π/2−β′

∠QPB′=β′+φX

B′Q, that is, y0′ can be obtained from the picture, using the following equation:

B′Q=y0′=ω5×Y0/Ymax (93)

where ω5=2×\sqrt{(L0′²+H0′²)}×tan(φ′/2), and Y0 is a distance in a Y direction between the foot root and the picture center in the picture screen. The other sides can be obtained, using the following equations:

B′P=y0′×sin(∠B′QP)/sin(∠QPB′)=y0′×sin(π/2−φ′/2)/sin(β′+φ′/2)

### B′ P is a distance y0.

y0=y0′×sin(π/2−φ′/2)/sin(β′+φ′/2) 94

B″P=y0×sin β′ 95

An image 31 of the person in FIG. 5a is amplified to be times of (B′Q/B″P) as large as that disposed at a point of B′. In a case of estimating this image, it is better to amplify the standard characteristic quantities to be times of (B′Q/B″P) as large as that and then compare. In a case where a person goes away from the point B′ in the contrary, normal processing can be performed by calculating in a similar manner and estimating. In this manner, even within the same picture screen, it is necessary to change the characteristic quantities of standard according to what amount a portion of a person contacting the ground surface is separate from the picture center. Let the characteristic quantities obtained on the basis of teaching data be κm5, κc5, κi5, λm4, λc4 and λi4, the characteristic quantities after correction are as follows:

κm5″=κm5×B′Q/B″P (96)

κc5″=κc5×B′Q/B″P (97)

κi5″=κi5×B′Q/B″P (98)

λm5″=λm5×B′Q/B″P (99)

λc5″=λc5×B′Q/B″P (100)

λi5″=λi5×B′Q/B″P (101)

By estimating, newly using the characteristic quantities κm5″, κc5″, κi5″, λm4″, λc4″ and λi4″, excellent results can be obtained. As the angle of elevation β′becomes large, the effect becomes large and can not become ignored.

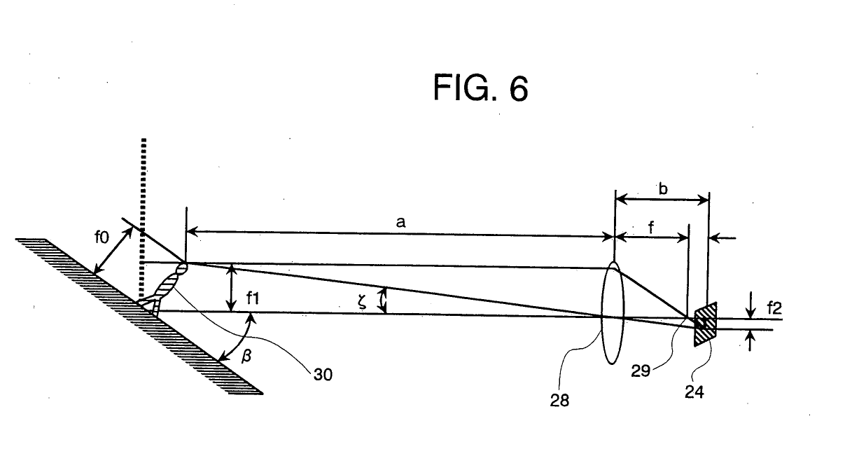

FIG. 6 shows a state in which an image of a detection object 30 is taken on the picture screen 24 by the lens 28. A person stands strictly on the ground, but the camera view line inclines against the ground surface by an angle β. Let the height of the person be f0, the height becomes f1 when it is projected on a plane perpendicular to the camera view line.

f1=f0×cos β (102)

f1 becomes an effective height of the camera and corresponds to an image height f2. A view field angle ζ of the object is as follows:

ζ=tan⁻¹f1/a 103

There is the following relation between the image heights f2 and f1:

a/f1=b/f2 104

Since b=f because an image is formed at a lens focus in usual, the following is established:

a/f1=f/f2, or a/f=f1/f2 105

In this manner, in the image processing, it is important to perform image processing after sufficiently acknowledging how the image is formed through an optical system.

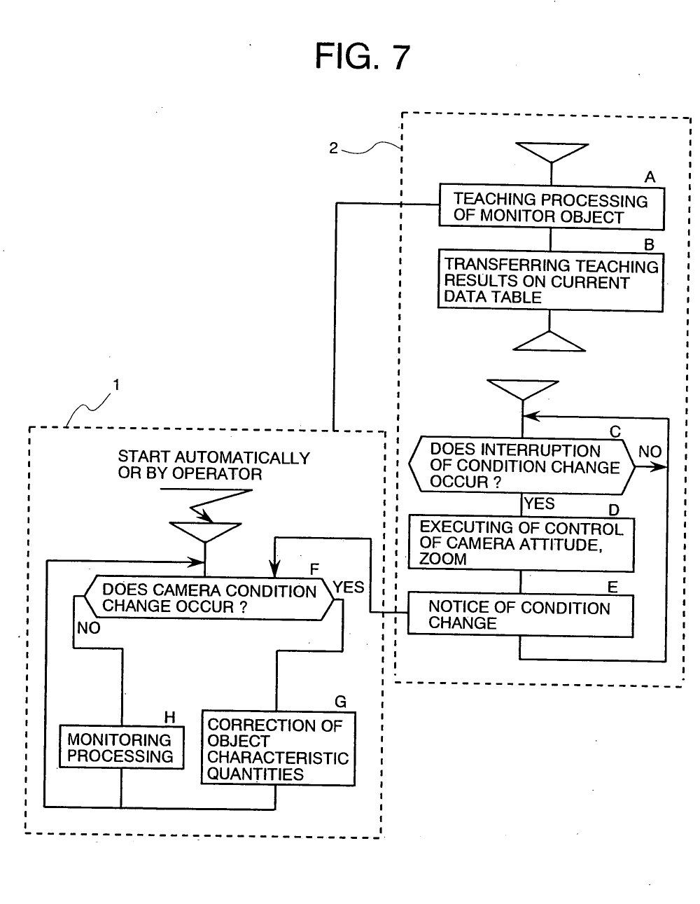

FIG. 7 shows a whole flow chart of monitoring of intruders. In advance to monitoring processing, characteristic quantities of an object to be monitored is taught into the apparatus and the results are written on the teaching data section 19a (step A), further, the result are written on the current table 19b so as to go on the monitoring processing under the conditions as it is (step B). The flow enters the monitoring processing after preparation working of such a pretreatment. The monitoring processing is started by automatic operation or operator operation. Whether or not there is an intruder is monitored (step H) while monitoring whether or not the camera conditions change (step F). A demand of changing the camera conditions occurs by intervening of the operator from the man-machine interference 22. In a case where the demand of changing the camera conditions is required (step C), control of camera attitude and zoom control processing are performed by intervening of an operator (step D). Those processing is performed by the system management controlling means 2, the man-machine interface 22, the video devices controlling means 5, etc. according to their roles, however, those processing are similar to that of general video devices, so that their details are not described here. Control information concerning the camera attitude and lens zoom is transmitted to the rotatable table 4 and the ITV camera 3 to operate them. The control results are quantatively expressed in numeral values, and transmitted to the intruder monitoring apparatus main unit 1 through the external interface 21 together with a condition change notification. In the intruder monitoring apparatus main unit 1, monitoring processing is performed (step H) while monitoring whether or not the camera condition changed (step F). When a change in the camera conditions is detected (step F), the camera attitude control information managing means 16, the lens zoom information managing means 17, the video device control information table 13 and the detection object characteristic quantity renewing means 18 perform detection object characteristic quantity correction processing (step G). The result is treated as follows, that is, video device control information is memorized in the video device control information table 13, and the characteristic quantities are memorized in the detection object characteristic management table 19. The detection object characteristic quantities after correction are used in later monitoring processing (step H). The present invention is constructed in this manner, so that image processing can well correspond to a change in the video system and intruder monitoring can be performed smoothly or effectively.

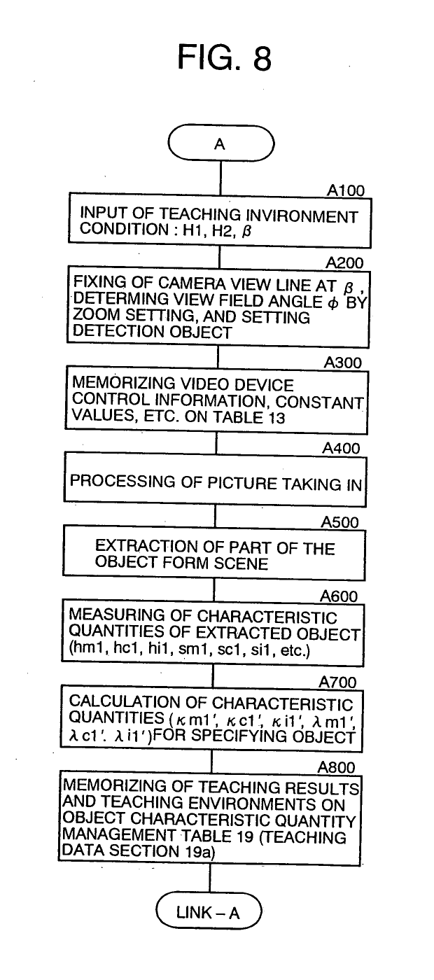

FIG. 8 shows an example of detection object teaching processing.

First of all, processing of inputting a camera mounting height H1, an elevation height difference H2, a camera angle of elevation β, etc. is performed (step A 100). Next, a view line is adjusted to a camera angle of elevation β by controlling the camera attitude and fixed thereto. Further, a view field angle φ is determined by adjusting the lens zoom. And then, an object is set (step A 200). The video device control information, constant values, etc. are stored in the video device control information table 13 (simply expressed table 13 in the Fig.)(step A 300). An image is taken (step A 400) and the object is extracted (step A 500). Characteristic quantities of the extracted object such as the height (hm1, hc1, hi1), area (sm1, sc1, si1), etc. are measured (step A 600). The characteristic quantities are calculated according to the following equations:

κm1=hm1/ω 106

κc1=hc1/ω 107

κi1=hi1/ω 108

λm1=sm1/ω 109

λc1=sc1/ω 110

λi1=si1/ω 111

where ω is a picture size (height) in pixel (picture element) number expression.

Next, in a step A 700, standard characteristic quantities for specifying the object are calculated. The following quantities are newly defined as the standard characteristic quantities and used.

κm1′=κm1×ω1×cos β 112

κc1′=κc1×ω1×cos β 113

κi1′=κi1×ω1×cos β 114

λm1′=λm1×ω1²×cos β 115

λc1′=λc1×ω1²×cos β 116

λi1′=λi1×ω1×cos β 117

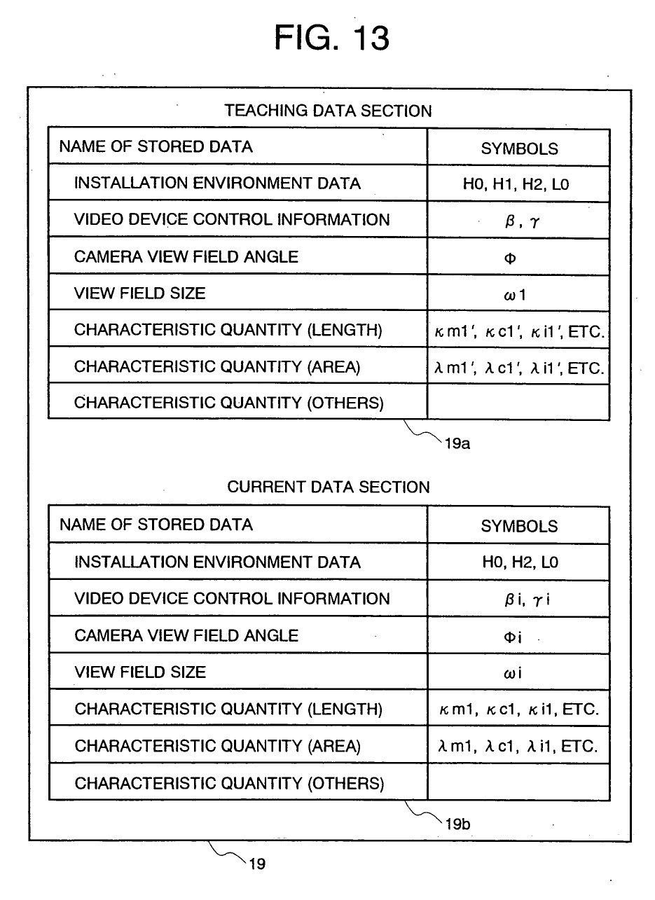

As above, κm1′, κc1′, κi1′, λm1′, λc1′ and λi1′ are calculated as taught standard characteristic quantities. These data are memorized in the object characteristic quantity management table 19 as shown in FIG. 13 (step A 800). The object characteristic quantity management table 19 comprises two parts as shown in FIG. 13, here, the data are memorized in the part 19a for memorizing teaching data.

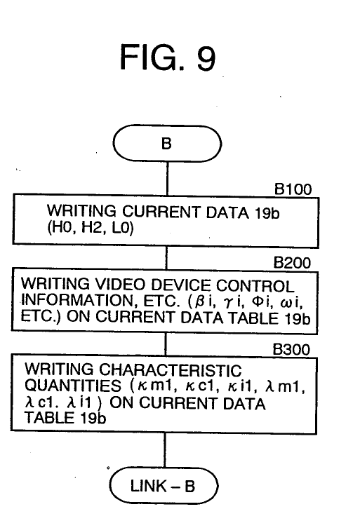

FIG. 9 is a flow chart of processing of memorizing characteristics and parameters used at the time of monitoring. Storing table is the current data table shown by 19b of FIG. 13. In this table, a part of environment conditions during monitoring and the standard characteristic quantities are memorized. At the time of monitoring, the data are employed to specify an intruder or intruders. Environment data such as H0, H2, L0 are written (step B 100).

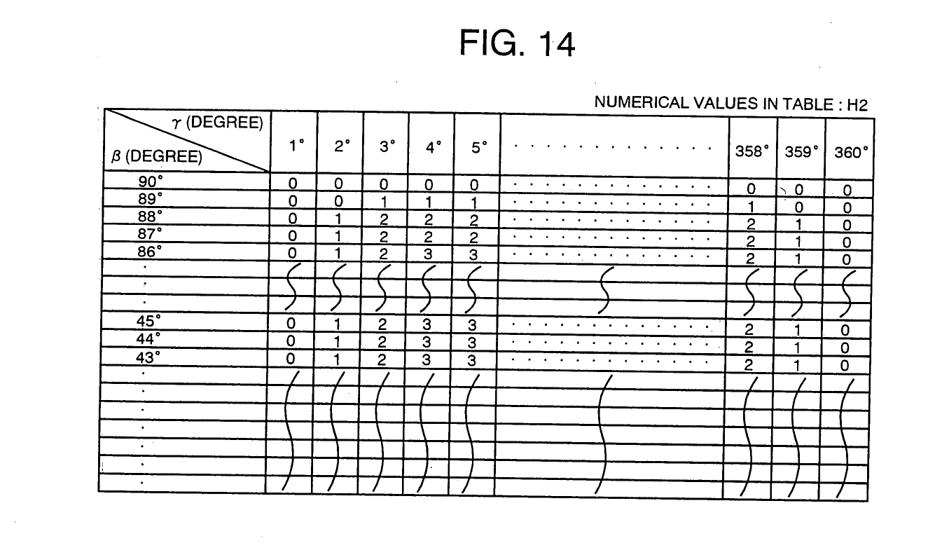

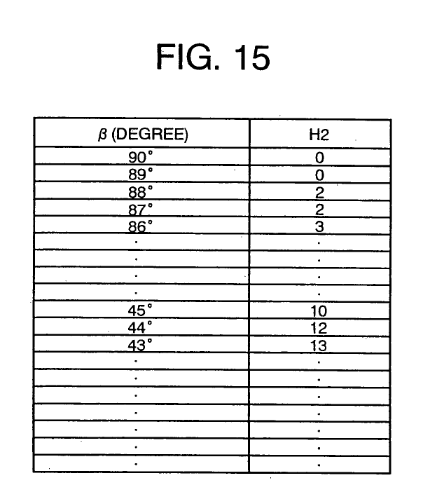

H2: The position of a cross point (point B) between a camera view line and the ground surface changes according to a change in camera attitude. Here, in order to determine the point B, map information of the topographic information table 20 is used. Point B in any camera attitude can be found according to this information. It is possible to prepare a numeric table by which H2 according to camera orientation (horizontal and vertical directions) can be directly found. An example of such a table is shown in FIG. 14. An elevation height difference H2 can be found from a camera horizontal direction angle γ and a camera vertical direction angle β. In a case of a flat ground floor, there are cases where an elevation height difference H2 can be determined by only a camera vertical direction angle β, and FIG. 15 is an example of them.

H0: it is calculated according to the following equation:

H0=H1+H2

L0: it is calculated according to the following equation:

L0=H1×cot β

As current video device control information, an angle of elevation of camera βi, a camera horizontal angle γi, a view field angle φi and a view field height ωi are memorized (step B 200). They are determined as follows:

βi: An angle of elevation β of the video device control information table is transferred without changing it.

γi: An angle of elevation γ of the video device control information table is transferred without changing it.

φi: A view field angle φ of the video device control information table is transferred without changing it.

ωi:ωi=2×\sqrt{(L0²+H0²)}×tan(φ/2)

Next, characteristic quantities κmi, κci, κii, λm1, λci and λii are written (step B 300). The characteristic quantities are modified numeral values of the teaching data table 19a. The calculation equations are as follows:

κmi=κm1′/(ωi×cos βi) 118

κci=κc1′/(ωi×cos βi) 119

κii=κi1′/(ωi×cos βi) 120

λmi=λm1′/(ωi²×cos βi) 121

λci=λc1′/(ωi²×cos βi) 122

λii=λi1′/(ωi²×cos βi) 123

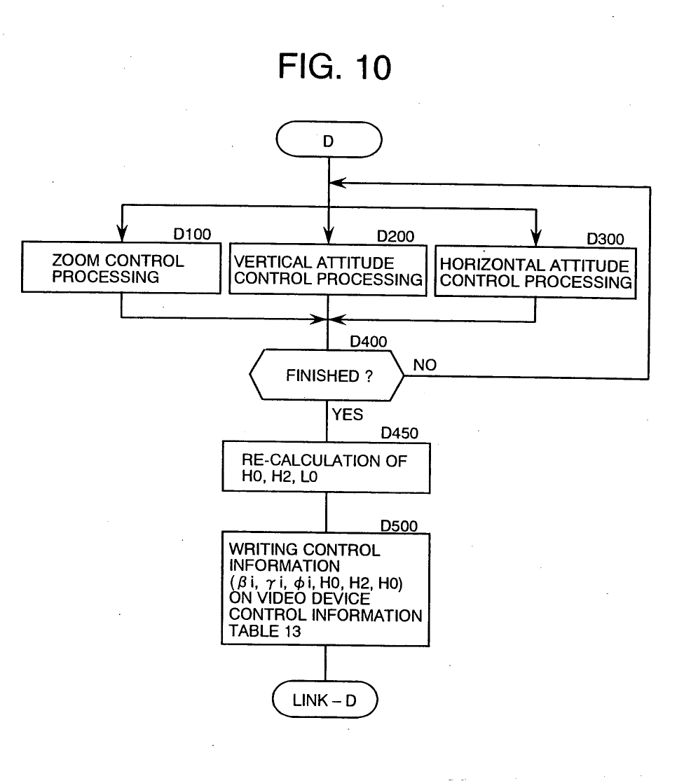

FIG. 10 is a flow chart of processing of camera attitude control and zoom control. Those processing are operated by an operator through the man-machine interface 22. The processing comprises three operations, that is, the zoom control processing (step D 100), vertical direction attitude control processing control (step D 200), horizontal direct-ion attitude control processing control (step D 300). After finishing the processing (step D 400), H0, H2 and L0 are re-calculated (step D 400). The calculation method is the same as in FIG. 9. Next, the control information table is renewed (step D 500). That is, it is to write new data into the video device control information table 13.

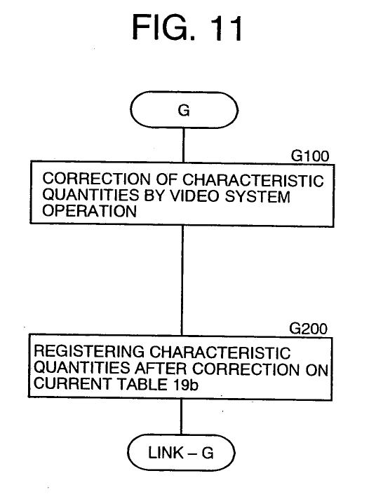

FIG. 11 is a flow chart of correction of the standard characteristic quantities when the a change in camera conditions occurs and processing of registration of them into the current table. The correction of the standard characteristic quantities (step G 100) is performed as follows:

Calculation of a view field size (height)ωi is as follows:

ωi=2×\sqrt{(L0²+H0²)}×tan(φi/2) 124

Re-calculation of the characteristic quantities is as follows:

κmi=κm1′/(ωi×cos βi) 118

κci=κc1′/(ωi×cos βi) 119

κii=κi1′/(ωi×cos βi) 120

λmi=λm1′/(ωi²×cos βi) 121

λci=λc1′/(ωi²×cos βi) 122

λii=λi1′/(ωi²×cos βi) 123

The characteristic quantities after correction is rewritten into the current table 19b (step G 200).

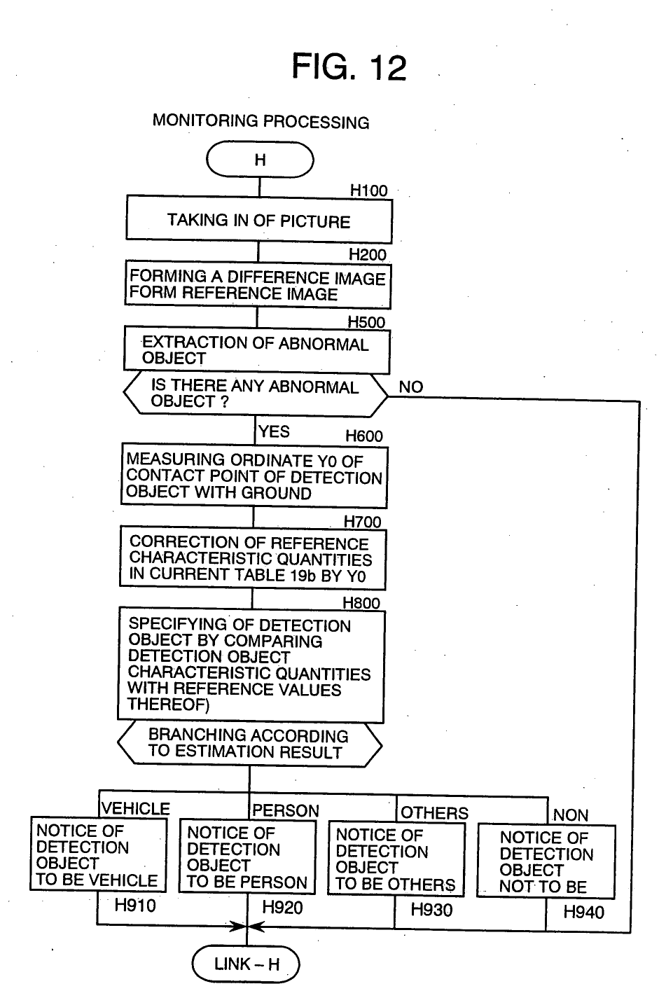

FIG. 12 shows an example of the monitor processing. A picture is taken in (step H 100), a difference image between an standard image is formed (step H 200). An abnormal object is detected using the difference image (step H 500). When it was detected, a distance Y0 between a contact point of the detected object with the ground surface and the picture screen center is measured. A process of correction of Y0 is described hereunder.

B′Q=y0′=ωi×Y0/Ymax

B′P y0′×sin(π/2−φ′/2)/sin(β′+φ′/2)} 125

where Ymax is a size (height) of the picture screen (line numbers).

B″P=y0×sin β′ 126

κmi″=κmi×B′P/B″P 127

κci″=κci×B′P/B″P 128

κii″=κii×B′P/B″P 129

λmi″=λmi×B′P/B″P 130

λci″=λci×B′P/B″P 131

λii″=λii×B′P/B″P 132

The detected objected is specified using the above corrected characteristic quantities (step H 800). When the following two equations are satisfied, the detected object image is specified as a person and then the process goes to a step H 920.

κmi×(1−Δ)≦hx/ω≦κmi×(1+Δ) (133)

λmi×(1−Δ)≦hx/ω²≦λmi×(1+Δ) (134)

Here, Δ is a value determined by what extent of variation a real value hm and a value hm4 in the picture have in the case of a person.

In the similar manner, in a case where the following two equations are satisfied, the object is specified as a vehicle and the process goes to a step H 910.

κci×(1−Δ)≦hx/ω≦κci×(1+Δ) (135)

λci×(1−Δ)≦hx/ω²≦λci×(1+Δ) (136)

### Practice Example 1

An example of practice is explained hereunder in which the above-described intruder monitoring apparatus is applied to a system which has no camera attitude controlling means and has a function of camera zoom control. In FIG. 1, only camera zoom control operation is possible by the man-machine interference 22. Accordingly, a camera angle of elevation β is constant, and the conditions explained of FIG. 2c can be applied to this case. A detection object can not be specified by the characteristic quantities which is taught changeable of the view field angle φ, however, according to this method, the detection object can be always normally specified because the characteristic quantities are corrected by a changed amount of the angle φ. In this method, as for the topographic information, it is sufficient if there is the least pieces of information. That is, at beginning, it is sufficient if H0, H1 and the camera angle of elevation β are known.

### Practice Example 2

An example of practice is explained hereunder in which the above-described intruder monitoring apparatus is applied to a monitoring system which monitors a flat and horizontal place before the camera setting position. In FIG. 1, the example is a case where zoom of the camera lens and vertical and horizontal control of the camera attitude can be operated through the man-machine interference 22. Because of the condition that the place before the camera is flat, H2 does not change by a horizontal shift of the camera attitude control operation. Only a vertical change of the camera attitude is concerned with the camera angle of elevation β. The conditions explained of FIG. 3a can be applied to this example. In this case, because of the condition that the place before the camera is flat, H2 is constant even if the camera angle of elevation β. Therefore, it is noted that the topographic information is sufficient to be the least. That is, it is sufficient if H0, H2 are known at beginning.

### Practice Example 3

An example of practice is explained hereunder in which the above-described intruder monitoring apparatus is applied to a monitoring system which monitors a place where is not flat but inclines before the camera setting position and where a horizontal change of the camera attitude is unnecessary. In FIG. 1, the example is a case where only zoom of the camera and vertical and horizontal control of the camera attitude can be operated through the man-machine interference 22. Since the place before the camera is not flat, H2 also changes according to change in camera angle of elevation β. The conditions explained of FIG. 3c can be applied to this example. In this case, as for the topographic information, it is sufficient to prepare only a table of the camera angle of elevation β and an elevation height difference H2.

### Practice Example 4

An example of practice is explained hereunder in which the above-described intruder monitoring apparatus is applied to a monitoring system which has functions of vertical and horizontal control operations of camera attitude and zoom control operation and is able to monitor a monitoring area which is not flat. In FIG. 1, the example is a case where zoom of the camera and vertical and horizontal control of the camera attitude can be operated through the man-machine interference 22. Since a monitoring area is not flat, the camera angle of elevation β changes and H2 also changes by horizontal operation of the camera. The conditions explained of FIG. 3c can be applied to this example. In this case, as for topographic information, it is necessary to be obtained from the camera angle of elevation β and camera angle horizontal direction r. By this construction, since H2 in any camera orientation can be obtained, the characteristic quantities can be corrected every change in the camera orientation and the detection object can be normally specified.

The embodiment of the present invention has the following effects;

1) When an intruder is detected, in the case of specifying it as a person, vehicle, etc., a conventional intruder monitoring apparatus or method could not specify it in some cases when there is a change in the camera zoom or attitude, however, this embodiment can normally specify it even if there is such a change:
2) In a case where a ground surface is viewed by the camera in a inclined direction, size of stain of an image caused by difference in distance between the object and the camera differs according to a position, even in the same picture frame. Therefore, a conventional apparatus or method could normally specify at a place closer to or farther from the center of the picture frame (scene), however, this embodiment can specify normally irrespective of distance between the object and camera: and
3) This embodiment is convenient because teaching processing is not necessary to effect every change in the zoom and attitude of the camera by memorizing control information and characteristic quantities of the camera zoom and attitude and correcting the corresponding characteristic quantities, etc. when they change.

Another embodiment of the present invention is described hereunder, referring to the drawings.

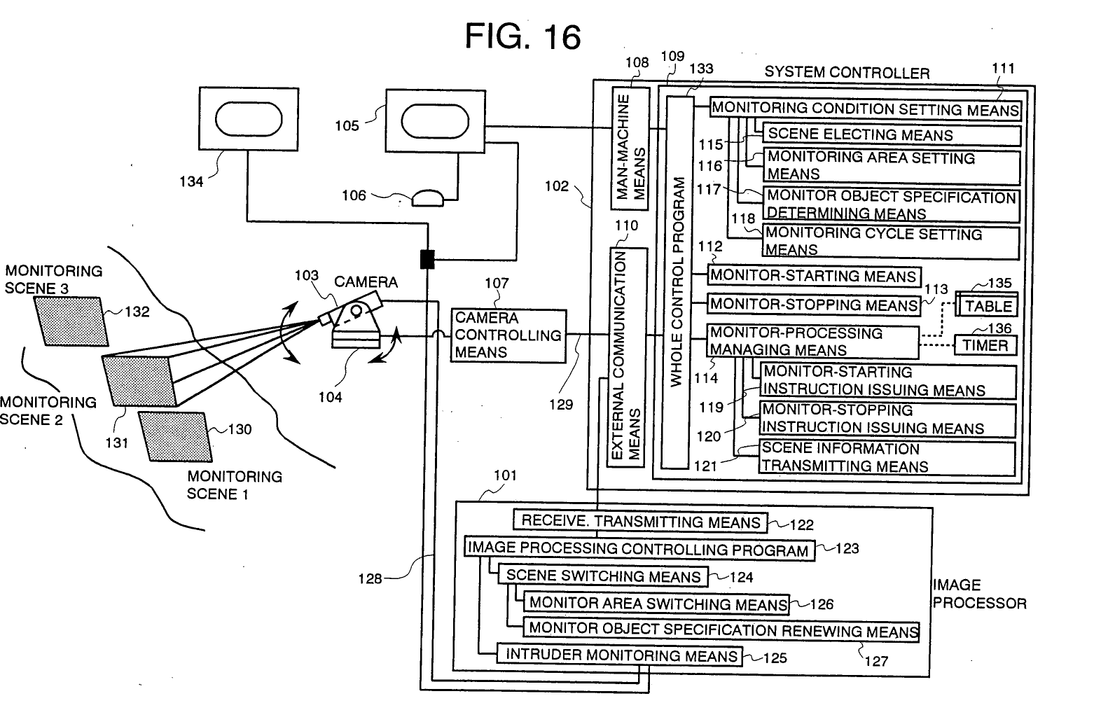

The whole of an intruder monitoring apparatus of an embodiment of the invention is shown in FIG. 16.

In FIG. 16, a camera 103 has a presetting function and is mounted on a movable table 104 which is rotatable about a vertical axis of the camera and a tiltable on a vertical plane passing the camera. The camera 103 is constructed so that a plurality of monitoring areas on the ground can be monitored by the presetting function. The plurality of areas, for example, an area 30 (scene 1), an area 31 (scene 2) and an area 32 (scene 3) can be taken picture by changing a direction of the camera 103 to input three scene images. The number of monitoring areas is determined to be 8 areas, 16 areas, etc. by a structural specification of the moving table 104. Basically, any number of areas can be preset. Camera images are taken in an image processor 101 and analyzed there to process monitoring of an intruder or intruders. The monitoring is effected only during stopping of movement of the camera 103 directed to a specific scene but not effected during changing of the direction of the camera 103 so as to be directed to another scene. A system controller 102 controls video devices and the image processor 101. The controller 102 is connected to a display device 105 for operation and a mouse 106, and an operator operates the controller 102 through operation of the mouse 106. The image processor 101 takes in video signals of camera images through a cable 128. Image processing results can be displayed on any one of a monitor TV 134 and the display device 105 because they are connected to the image processor 101 by interface cables. Camera control is effected by a camera controlling means 107 which is connected to the controller 102 through an interface cable 129 and receives control signals from the controller 102 therethrough.

The controller 102 comprises a man-machine means 108, a control management main unit 109, an external communication means 110, etc. The control management main unit 109 comprises a whole control unit 133, a monitoring condition setting means 111, a monitor-starting means 112 for starting monitoring, a monitor-stopping means 113 for stopping monitoring, a monitor-processing managing means 114, a table 135, a timer 136, etc. The monitoring condition setting means 111 includes a scene election means 115, a monitoring area setting means 116 for setting monitoring areas in each scene, a monitor object specification determining means 117 for determining a specification of an object to be monitored or detected, a monitoring cycle setting means 118. The monitor-processing managing means 114 includes a monitor starting instruction issuing means 119, a monitor interruption instruction issuing means 120, a scene information transmitting means 121. The image processor 101 comprises a signal transmitting and receiving means 122, an image processing controlling or managing program 123, a scene switching means 124, an intruder monitoring means 125, a monitoring area switching means 126 and a monitor object specification renewing means 127.

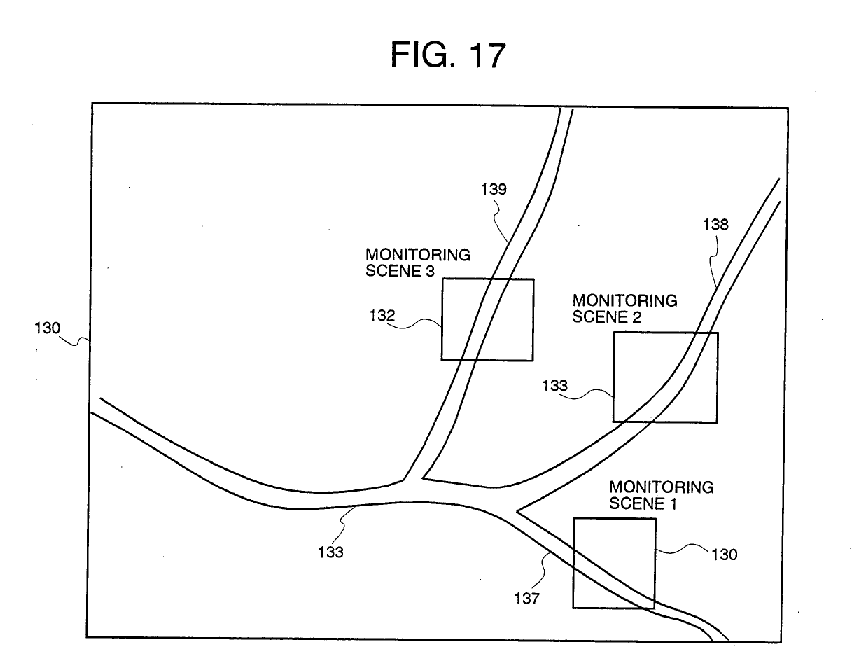

Referring to FIG. 17, an example of forming monitoring scenes will be explained hereunder.

Assuming that there are roads 133, 137, 138 and 139 as shown in FIG. 17, when all the roads appeared in FIG. 17 are intended to be monitored by one camera, objects to be monitored are too small to monitor them, therefore, it is possible to set three monitor areas 130, 131 and 132 (scenes 1 to 3), for example, and monitor them by one camera. In this case, the three scenes 1, 2 and 3 are cyclically monitored by one camera 103 in this embodiment. Since each of the above-mentioned scenes 1 to 3 is sufficiently wide relatively to a moving speed of a monitor object or objects, if the scenes are monitored at a certain periodic intervals, the object or objects are surely detected when they pass the scenes. In this manner, in a case where there is a specific relation between a moving characteristics of an object and the width of monitoring area, it is unnecessary to continuously monitor objects.

Let a speed of an object passing a scene and a distance of a passing road to be V (m/s) and L (m), respectively, a monitoring period is necessary to be ΔT (sec) or less:

ΔT=L/V

### An optimum period is (0.1-0.5)ΔT.

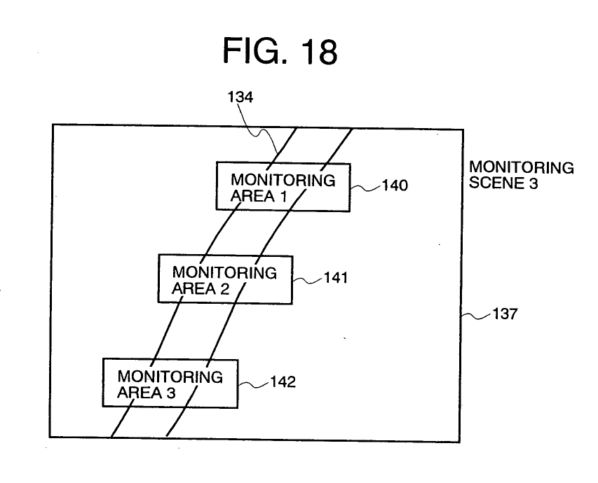

Referring to FIG. 18, it will be discussed that a road 134 passing in a camera image 137 (in the monitoring scene 3) is monitored. A backward portion of the scene is nearer to the camera than a forward portion. An object or objects can not be specified or classified well enough when image processing of the entire scene 3 is performed under the same conditions. Therefore, three areas 140 to 142, that is, an area 1, area 2 and area 3 are provided within the scene 3 along an object which is desired to be monitored. Each area 1, 2, 3 is monitored to detect an intruder according to each specification specific to each area 1, 2, 3, whereby specifying or classification of the object is carried out normally.

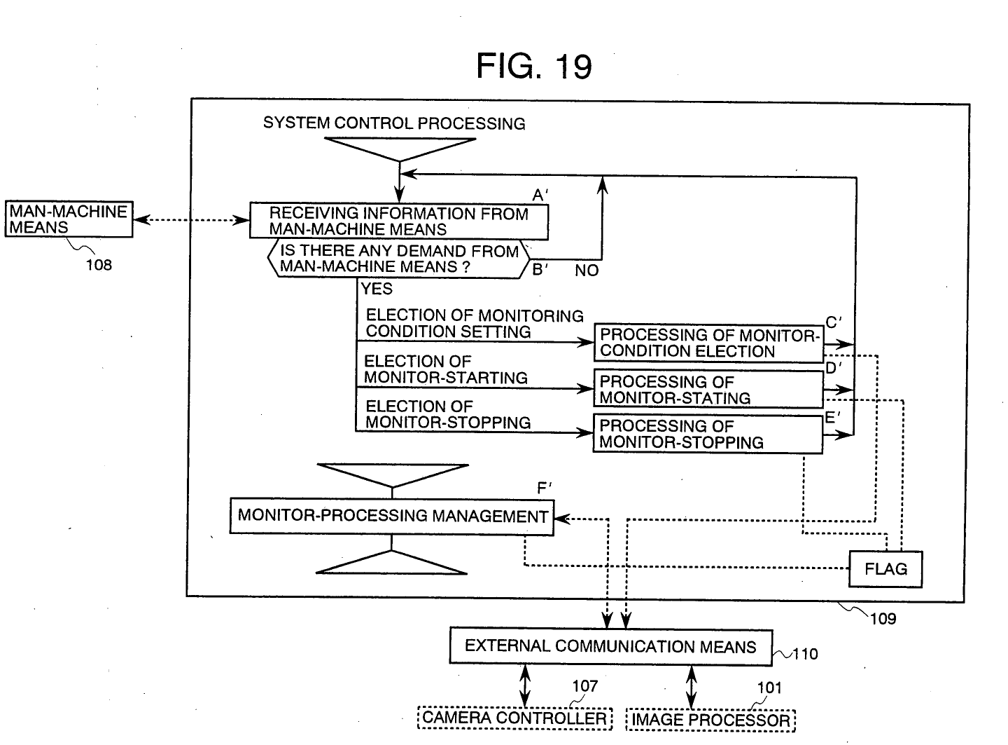

FIG. 19 shows a flow chart of an example of processing by the controller.

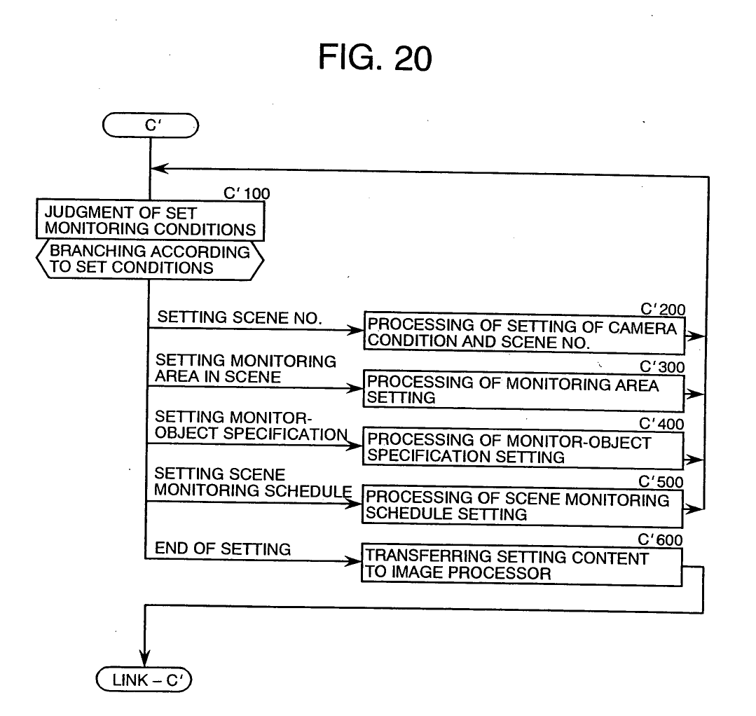

A content of operation by an operator is taken in the controller 102 through the man-machine means 108. Information (man-machine information) from the man-machine means 108 is input into the controller 102 (step A′) and the flow branches according to the information contents (step B′). The flow goes into step C′ in a case where a monitoring condition setting is elected, step D′ when a monitor-stating is elected, and step E′ when monitor-stopping is elected, respectively. The details of the steps C′, D′ and E′ are explained later, referring to FIGS. 20, 21 and 22.

Monitor-processing management (step F′) by the means 114 is a program which independently operates. The program effects receiving and transmitting of information from and to the camera controlling means 107 and the image processor 101 through the external communication means 110.

FIG. 20 shows a flow chart of an example of monitoring condition election processing (step C′).

The monitoring conditions which have been set are judged (C′100) and the flow branches according to the set monitoring conditions as follows:

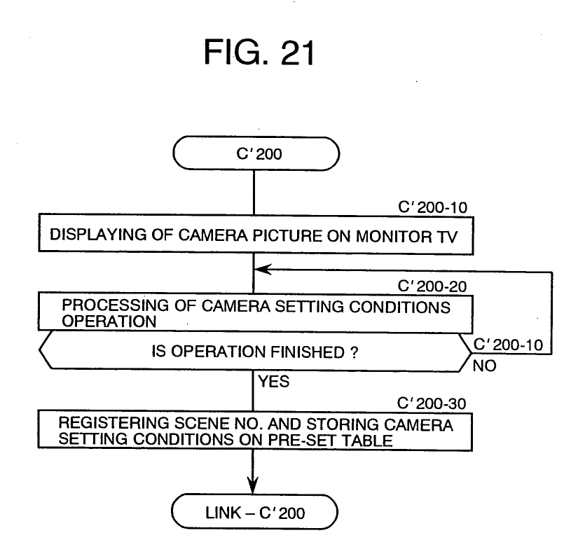

When the number of scenes of a monitor object is set (step C′), the flow transfers to a processing of setting camera conditions and the scene number (step C′200). When monitor areas are set in the scene, the flow transfers to a processing of setting of monitoring areas (step C′300). When monitor object specifications are set, the flow transfers to a processing of setting of monitor object specifications (step C′400). When a scene monitoring schedule is set, the flow transfers to a processing of setting a scene monitoring schedule (step C′500). When the setting processing are finished, the setting contents are transmitted to the image processor 101 (step C′600). The steps C′200, C′300, C′400 and C′500 are explained in detail, referring to FIGS. 21 to 23 and 26.

FIG. 21 shows an example of a flow of the processing of setting the camera conditions and scene numbers. First of all, a camera image is displayed on the monitor TV (step C′200-10). A scene to be desired to monitor is elected by changing the direction of the camera 103 (step C′200-20). After the scene setting is finished, the scene number and camera setting values are stored in the table as preset values (step C′200-30). In this manner, the scene to be desired to monitor is determined and preset.

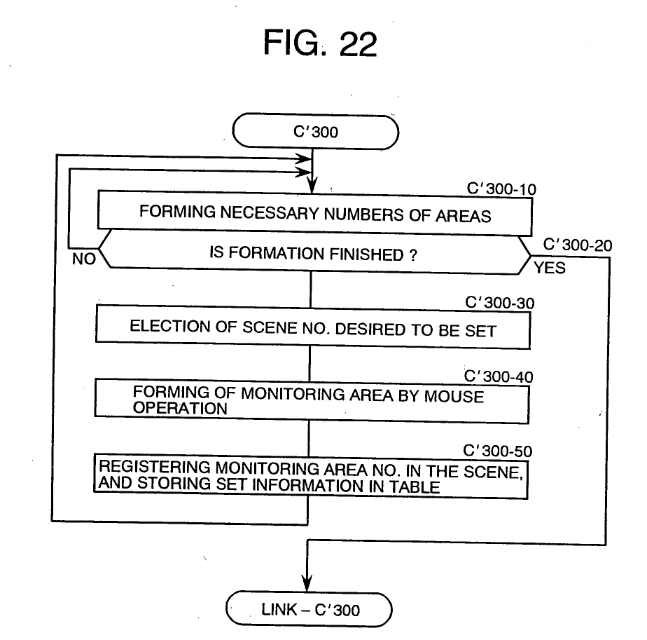

FIG. 22 is a flow chart of an example of a processing of setting monitoring areas. Here, any necessary monitoring area are provided within one scene (step C′300-10). It is judged whether or not the formation is finished (step C′300-20). First, the numbers of scenes desired to set are elected (step C′300-30). Next, the monitoring areas are formed by operation of the mouse (step C′300-40). Further, the monitoring area numbers are registered in the corresponding scenes, respectively, and the set information is stored in the table 135 (step C′300-50).

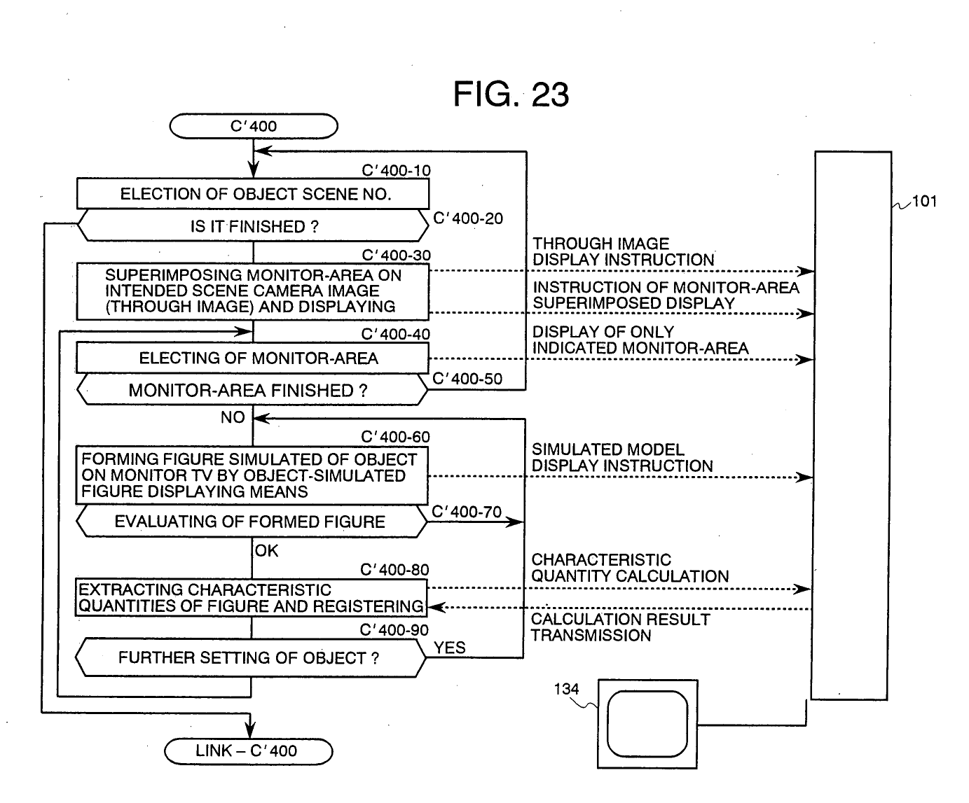

FIG. 23 is a flow chart of an example of a processing of setting a monitor object. An object scene number is elected (C′400-10). The following processing is performed until the processing of all the scenes are finished. A monitoring area is superposed on a camera image of the corresponding scene and displayed (C′400-30). A monitoring area is elected (C′400-40). After election of the monitoring area, a monitor object model is formed in the monitor TV (C′400-60). Characteristic quantities of an intruder are estimated by the object model. The details are described later. After the model formation is finished, characteristic quantities of the model are calculated, the result is stored in the table 135 (C′400-80). In this manner, the specification of the object is set.

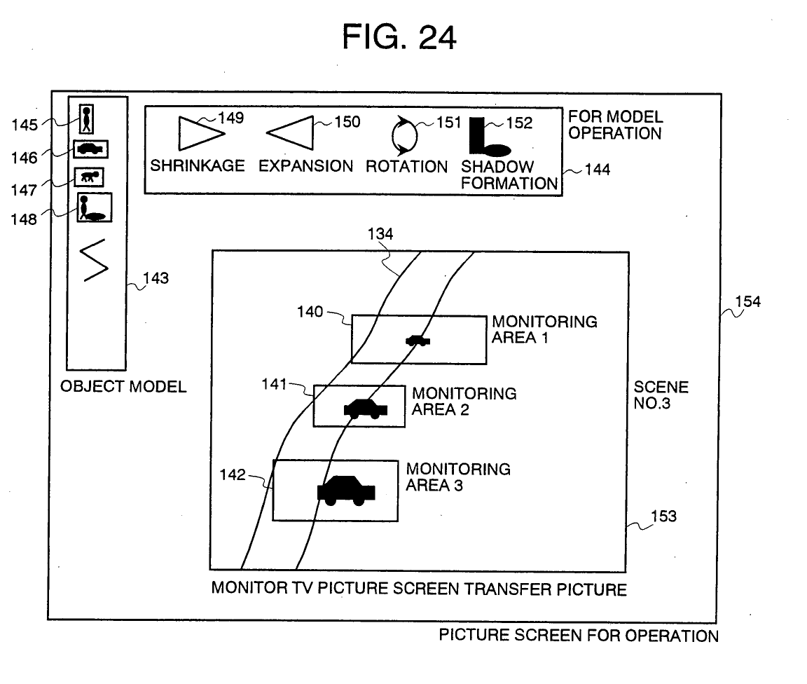

FIG. 24 shows an example of a method of forming a model of an object on a monitor TV. On the operation screen 154, an image 153 of the monitor TV is displayed. An icon 143 for object model and an icon 144 for model operation are prepared in advance. On the monitor screen 153, monitoring areas 140, 141 and 142 are displayed. On the icon 143 for object, various kinds of icons such as person icon 45, vehicle icon 146, small animal icon 147, icon with shadow 148, etc. are prepared in advance. Suitable icons of those icons are transferred onto the monitoring areas. In this manner, any object model images are formed on the monitoring areas. Since it is necessary to correct the size of formed model, the processing is explained hereunder. It will be understood to be easily able to shrink, expand, rotate, etc. the object models formed on the monitoring area. Further, in a case of a model without its shadow, there is an icon of adding a shadow. In this manner, in the scene, a model closest to the size of the object is formed.

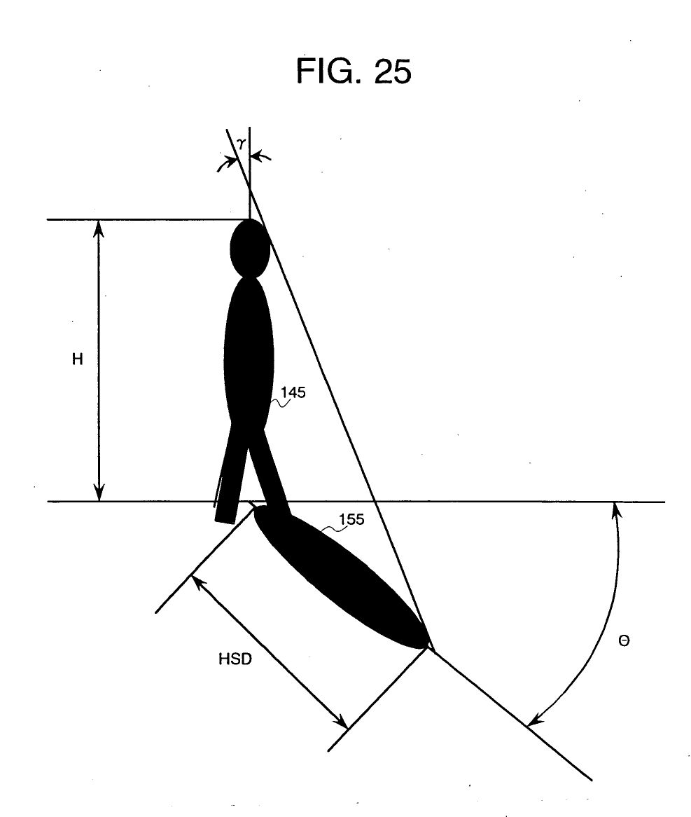

FIG. 25 is for explaining an example of a method of adding a shadow 155 to the model 145 without any shadow. In this method, it is necessary to indicate a direction θ in which the shadow is added, an angle of incident ray γ and the length HSD of the shadow. The angle and direction are determined by positional relation between the camera and an eliminant or the sun, and are determined outdoor as follows:

θ=θ(m,d,h)

γ=γ(m,d,h)

where m denotes month, d day and h o'clock. In this manner, in the case of the camera set at a specific position, they are determined by information of month, day, o'clock and so on,

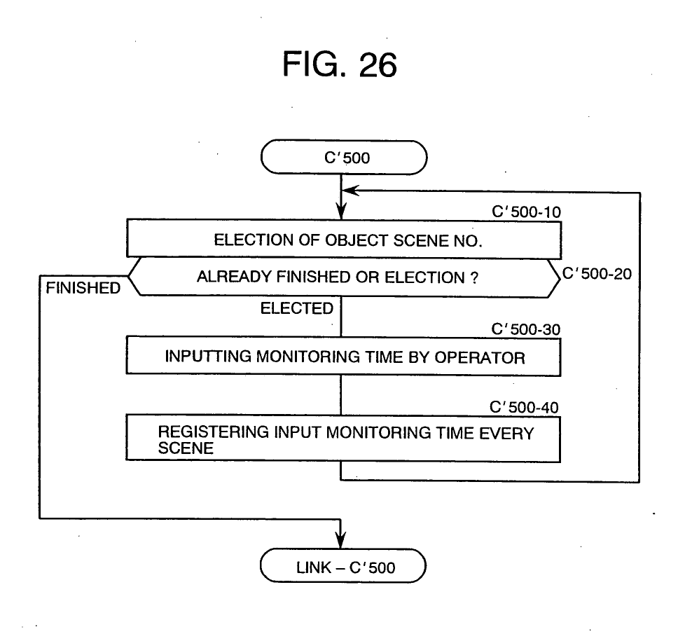

FIG. 26 shows a processing of scene monitoring schedule setting. Monitoring object scene numbers are elected (step C′500-10). It is judged whether or not the election has been finished before the step C′500-10 or is to be done (step C′500-20). After election, an operator inputs the monitoring time (step C′500-30), and the input monitoring time is registered every scene (step C′500-40).

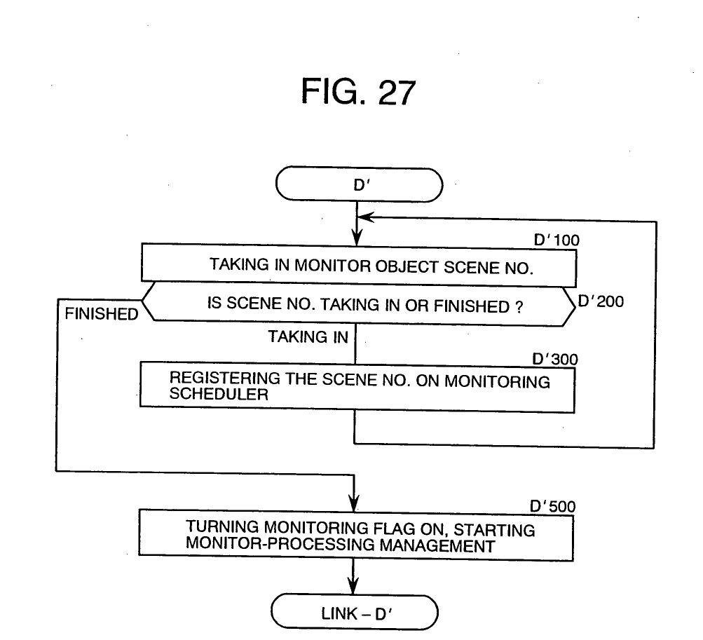

FIG. 27 is a flow chart of monitor-starting processing. Scene numbers of monitor object are taken in (step D′100). It is judged whether the election is being done of finished (step D′200). When being done, the elected numbers of monitoring object are registered in a scheduler (step D′300). Finally, a monitoring flag is turned on and starts the monitor-processing management program (step D′500).

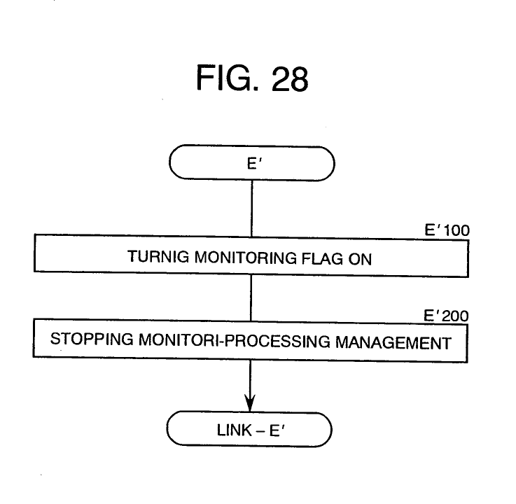

FIG. 28 is a flow chart of the monitor stopping processing. The monitoring flag is turned off (step E′100) and then stops the monitor-processing management (step E′200).

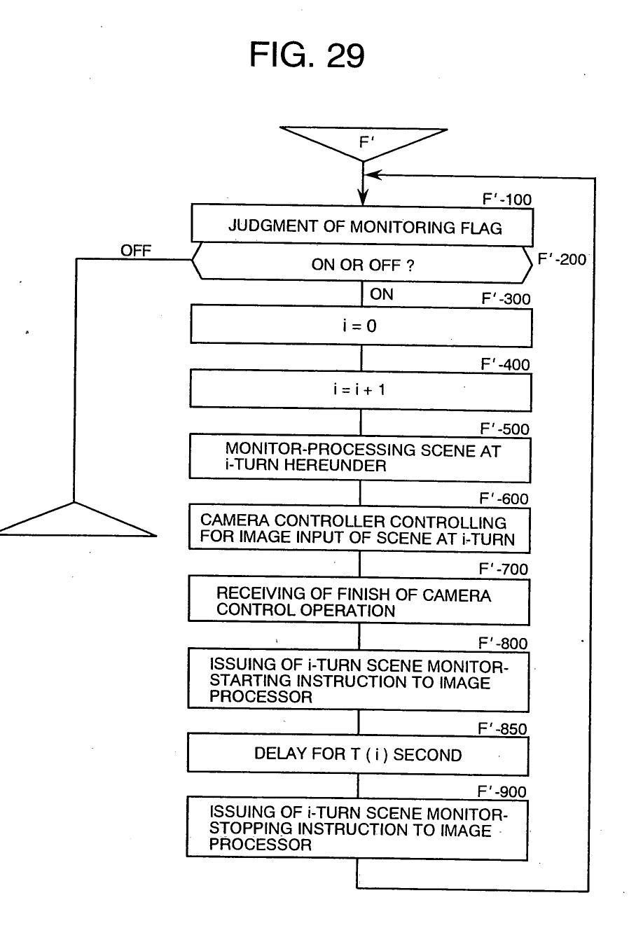

FIG. 29 is a flow chart of a processing of monitor-processing management. Here, the image processing camera controlling means and the image processor are driven or stopped timely. First, a processing is executed only when the monitoring flag is on (step F′100, F′200). The scene of i-turn is monitored in turn (step F′300 to F′500). The camera controlling means is controlled to input an image of the i-turn scene (step F′600), and after termination of the camera control operation is received (step F′700), a monitoring instruction for starting monitoring of the scene of i-turn is issued to the image processor (step F′800). After delay for T(i) seconds of the monitoring time (step F′850), a monitor-stopping instruction for stopping the monitoring of the i-turn scene is issued (step F′900).

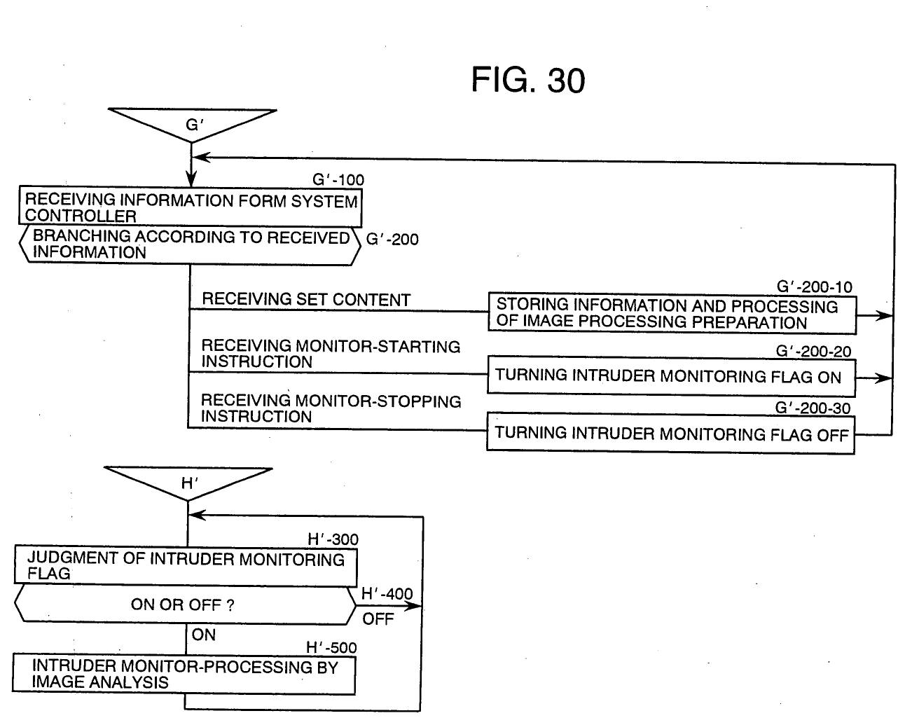

FIG. 30 is a flow chart of a processing content inside the image processor 101. In the management part, information is received from the system controller 102 (step G′100) and the flow branches according to the received information (step G′200). In a case where a setting content is received, the information is stored and preparation of image processing is done (step G′200-10). In a case where a monitor-starting instruction is received, the intruder monitoring flag is turned on (step G′200-20), and in a case of a monitor-stopping instruction, the intruder monitoring flag is turned off (step G′200-30). In the image processing execution processing part, the intruder monitoring flag is judged (step H′300, H′400). When the flag is on, the intruder processing is executed by image analysis (step H′500).

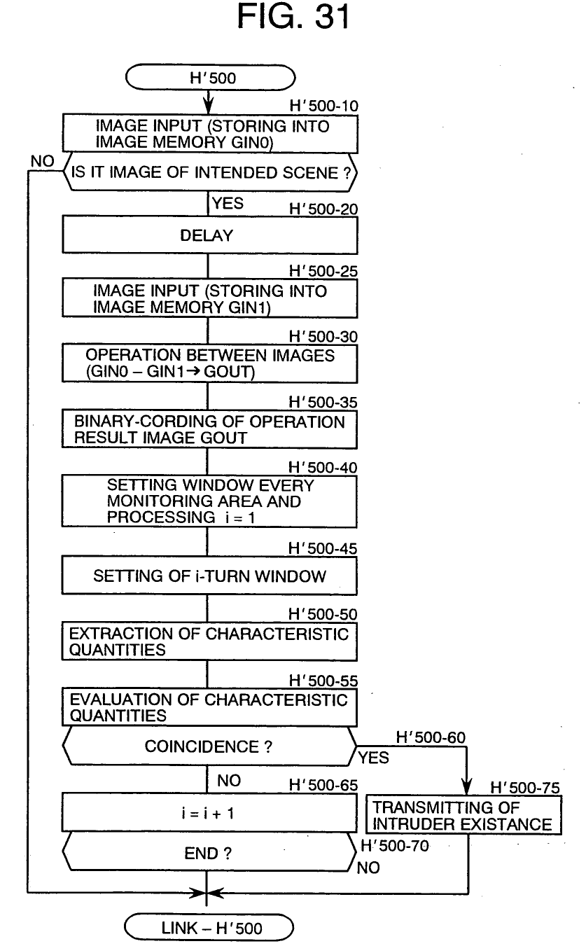

FIG. 31 is a flow chart of detailed process of the intruder monitoring by image processing. In the process, an image is input into an image memory G1N0 (step H′500-10), if the image is an image in the corresponding scene (step H′500-15), the following processing is executed:

After some delay of about 1-3 seconds (step H′500-20), an image is taken in again and input into an image memory G1N1 (step H′500-25). An operation (extraction, G1N0−G1N1=GOUT) between the above-mentioned two images is effected (step H′500-30). The result image is binary-coded (digitized)(step H′500-35) and windows are set every monitoring area (step H′500-40). A window of i-turn is set (H′500-45). When any image change every window inside is detected, characteristic quantities are calculated (step H′500-50). The characteristic quantities are evaluated (step H′500-55) and when they are coincided with reference characteristic quantities (step H′500-60), information of existence of an intruder is transmitted (step H′500-75). When not coincided, an image change of a further window of i+1 turn is evaluated and so on (step H′500-65) until end is confirmed (step H′500-70).

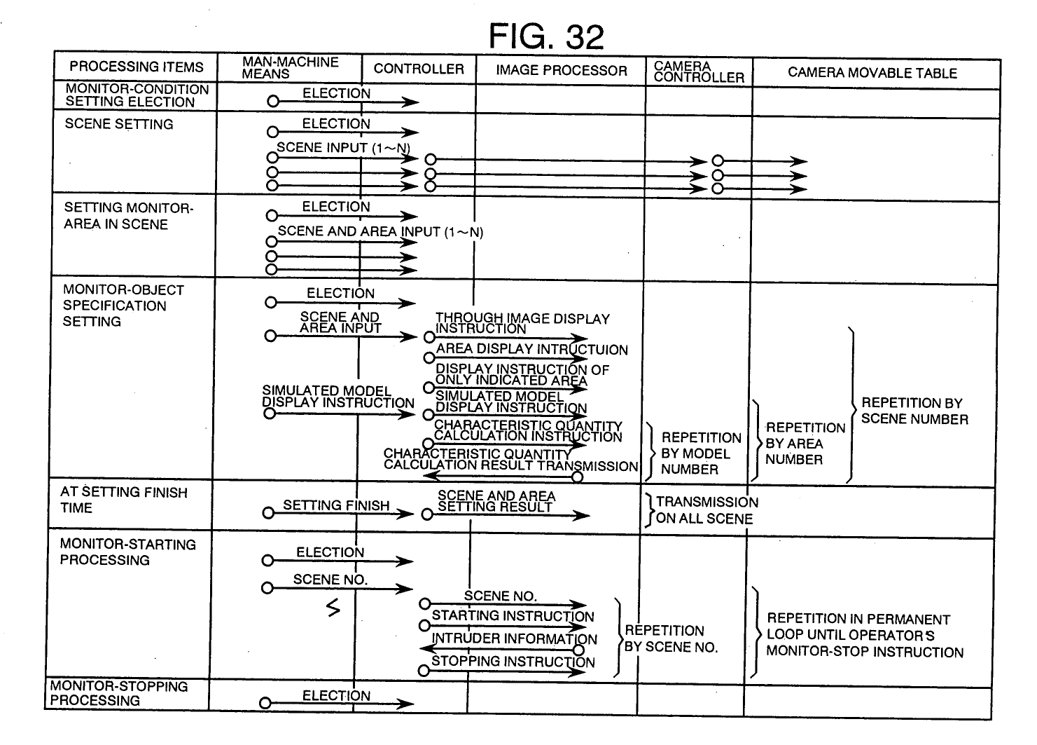

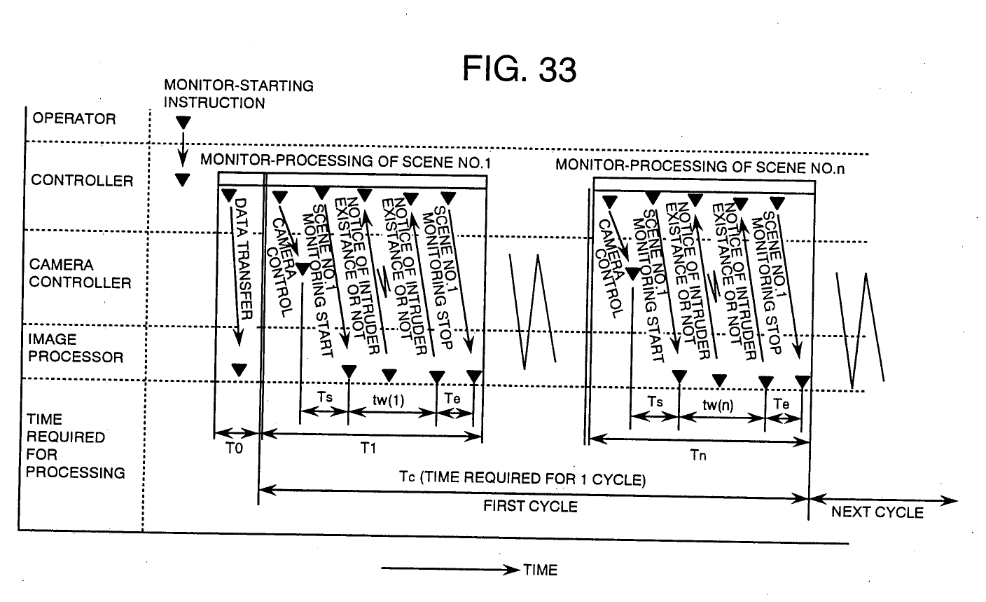

FIG. 32 shows the embodiment of the apparatus according to the present invention by a data flow. FIG. 33 is a time chart of the embodiment. In FIG. 32, T0 denotes a data transfer time from the controller 101 to the image processor 102 at the time of monitoring start. Ti is total time required for monitoring a scene of i-turn, and tw(i) is a real monitoring time. Ts is a time required for transferring a scene monitor-starting instruction, Te is a time required for scene monitor-stopping. Tc is a time required until once monitoring all the scenes is finished.

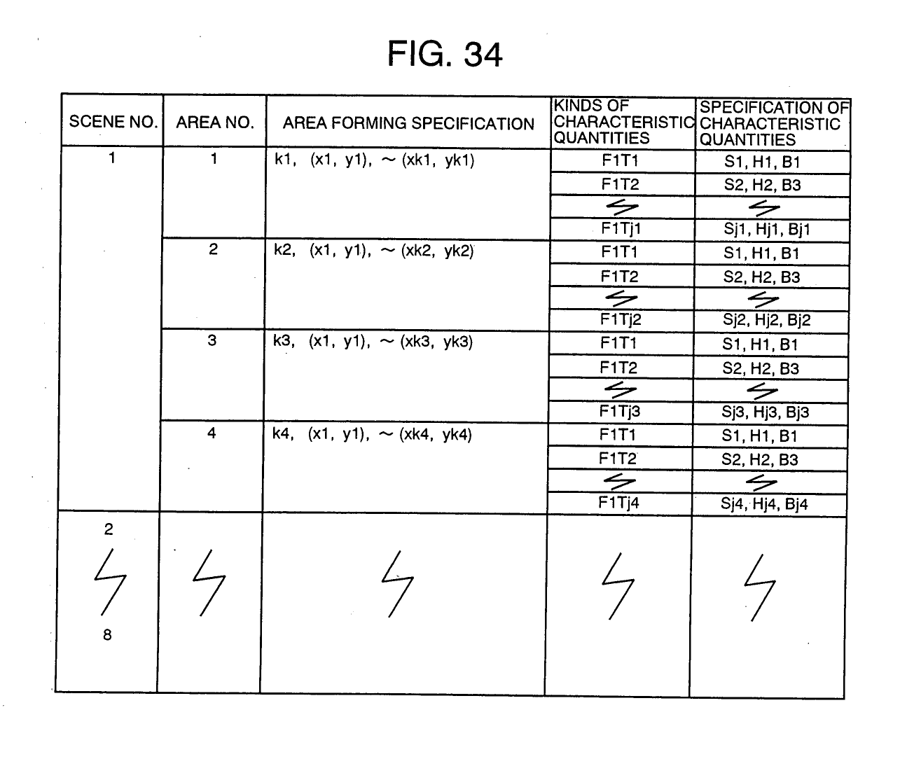

FIG. 34 shows a construction table of the table 135. The table comprises scene Nos, the area Nos, area forming specification part, kinds of characteristic quantities and specifications of characteristic quantities. One scene includes 4 area numbers at maximum (in this case, the area number is fixed at four, but any number can be taken), each area has point groups of coordinate systems for forming each area. The number ki of coordinate system point groups and each coordinate value are (x1, y1)˜(xki, yki). The kinds of characteristic quantities are F1T1˜F1T4. For each characteristic quantity, Si, Hi, Bi are prepared for storing calculation results.

According to this embodiment, one-camera can monitor a relatively wide range, and there are the following effects:

A construction cost of the intruder monitoring apparatus is low. An intruder or intruders of object can be surely monitored by taking a suitable monitoring space and monitoring period of one scene. It is expected that precision of classification of objects can be improved by providing a plurality of monitoring areas in one scene and making it possible to set characteristic quantities in one area independently from those in the other area. It is possible to easily set characteristic quantities by a method of forming a model of an object on a monitor TV.

What is claimed:

1. An intruder monitoring apparatus monitoring a wide area by changing a camera shooting direction comprising:
a monitoring camera for monitoring an area including an object, said monitoring camera being changeable in a shooting direction so as to monitor a wide area;
an image processor for analyzing an image from said monitoring camera;
a video device controller for controlling video devices including said monitoring camera;
means for managing a topographic information of the area to be monitored, and at least one kind of information selected from a group of video device control information used for controlling the video devices, and object characteristic quantity information which is information concerning characteristic quantities of the object;
means for teaching said image processor characteristic quantities of an object;
means for correcting and renewing the characteristic quantities, in response to the image analysis effected on the basis of topographic change of the area to be monitored, based on a change in shooting conditions of said video devices, using the topographic information stored in advance; and
means for detecting an object, referring to the renewed characteristic quantities.

2. An intruder monitoring apparatus according to claim 1, wherein the position of a part of the object in contact with the ground surface is measured, and the characteristic quantities of the object is corrected on the basis of a distance between the position of the image objects and the center of the scene.

3. An intruder monitoring apparatus according to claim 1, wherein reference characteristic quantities of the object are corrected using topographical information of an elevation difference between a set position of said camera and the center of a scene on the ground in a case where only the zoom of said monitoring camera is changeable, with any other conditions of video devices and environments being fixed.

4. An intruder monitoring apparatus according to claim 2, wherein reference characteristic quantities of the object are corrected using topographical information of an elevation difference between a set position of said camera and the center of a scene on the ground in a case where only the zoom of said monitoring camera is changeable, with any other conditions of video devices and environments being fixed.

5. An image processor for effecting detection by image analysis on the basis of characteristic quantities of an object to be detected and taken by a camera monitoring a wide area by changing a shooting direction thereof, comprising
a device for renewing the characteristic quantities of the object, on the basis of the image analysis effected, based on topographic change of an area to be monitored, caused by a change in shooting conditions by said camera, using topographic information stored in advance.

6. An intruder monitoring method of monitoring an object using a monitoring camera, analyzing an image of the object from said monitoring camera monitoring a wide area by changing a shooting direction thereof, controlling various video devices including the monitoring camera, a image processor, managing at least one kind of information selected from a group of video device control information used for controlling the video devices, object characteristic quantity information which is information concerning characteristic quantities of the object, and a topographic information of an area to be monitored, teaching the image processor characteristic quantities of the object, correcting and renewing reference characteristic quantities, in response to the image analysis effected, on the basis of topographic change of the area to be monitored, based on a change in shooting conditions of said video devices, by using the topographic information stored in advance, and detecting an object, referring to the renewed reference characteristic quantities.

7. An image processing method of effecting detection by image analysis on the basis of characteristic quantities of an object to be detected and taken by a camera monitoring a wide area by changing a shooting direction thereof, comprising a process of renewing the characteristic quantities of the object, on the basis of the image analysis effected, based on topographic change of an area to be monitored, caused by a change in shooting conditions by said camera, by using topographic change stored in advance.

8. An intruder monitoring apparatus according to claim 1, wherein said topographic change includes at least change in elevation angle of said monitoring camera.
